(19) United States
(12) Patent Application Publication
(10) Pub. No.: US 2016/0214399 A1
(43) Pub. Date: Jul. 28, 2016

(54) METHOD PROTECTING AND MAINTAINING LASER SYSTEMS USED FOR MARKING FOOD PRODUCTS

(71) Applicant: TEN Media, LLC dba TEN Ag Tech Co., San Juan Capistrano, CA (US)

(72) Inventors: Jonathan R. Phillips, San Juan Capistrano, CA (US); Richard C. Blackburn, Santa Ana, CA (US)

(73) Assignee: TEN Media, LLC dba TEN Ag Tech Co., San Juan Capistrano, CA (US)

(21) Appl. No.: 15/006,109

(22) Filed: Jan. 25, 2016

Related U.S. Application Data
(60) Provisional application No. 62/107,488, filed on Jan. 25, 2015.
(60) Provisional application No. 62/107,506, filed on Jan. 26, 2015.
(60) Provisional application No. 62/107,537, filed on Jan. 26, 2015.

(51) Int. Cl. B41J 3/407

(52) U.S. Cl. CPC B41J 3/4073

(57) ABSTRACT

The present disclosure includes a method and system for applying markings on a food product by applying a radiant energy to the food product in such a manner to form a permanent marking thereon. These systems and methods include laser configurations that provide for optimal marking while minimizing the quantity of egg stabilizers needed. The present disclosure further includes systems and methods for using shutters to provide a safety shutter mechanism for preventing accidental laser beam escape when guards are removed in addition to protecting the lens. The disclosure also has the benefit of preventing machinery damage, improving machinery performance and play a vital part in achieving predictable performance which is essential to safe operation of the radiant energy source. The present disclosure also includes methods and systems for protecting ink cartridges used in egg carton printing.

### CROSS-REFERENCE TO RELATED APPLICATIONS

This application claims the benefit of U.S. Provisional Application No. 62/107,488 filed on Jan. 25, 2015, U.S. Provisional Application No. 62/107,506 filed on Jan. 26, 2015, U.S. Provisional Application No. 62/107,530 filed on Jan. 26, 2015, and U.S. Provisional Application No. 62/107,537 filed on Jan. 26, 2015, the contents of which are incorporated herein by reference in their entirety.

### BACKGROUND

The disclosure relates generally to the field of food product processing, and more particularly to egg processing.

In the egg packing industry, eggs typically undergo a great deal of processing before they are ready to be sold to the consuming public. In many circumstances, for example, eggs pass through several processing stations where they are washed, candled, weighed, graded, and packed into packages (e.g., cartons, crates, or other commercially distributed containers). Examples of such processing stations and mechanisms for conveying eggs from station to station are described, for instance, in the following U.S. patents assigned to Diamond Automations, Inc. (U.S. Pat. Nos. 4,189,898; 4,195,736; 4,505,373; 4,519,494; 4,519,505: 4,569,444; 4,750,316; 5,321,491; and 6,056,341) and TEN Media LLC (U.S. Pat. No. 8,455,030), which are incorporated herein by reference in their entirety. As a reference, it is not uncommon for a facility in which these stations operate to output about one million eggs in a single day. Accordingly, to be commercially acceptable, the throughput of the stations needs to be quite high, with some stations typically processing on the order of 20,000 eggs per hour.

The egg packing industry uses devices known as “packers” to pack the eggs into the packages. Typically, a packer includes a conveyor (e.g., a belt conveyor, roller conveyor, chain conveyor, etc.) that moves empty packages through an egg loading section (where the eggs are loaded into the egg loading section from above) and then moves the filled packages to a package dosing section that is responsible for dosing the lids of the packages. The eggs may be supplied to the egg packer via a grader system.

An egg packing process that uses “packers,” typically uses bulk belts to bring eggs from a bulk supply location. The eggs are cleaned or disinfected, in some instances using UV light while clamped to transport chains, in some instances through immersion in sanitizing wash water. The eggs are then inspected either electronically or manually, they are weighed to establish size, inspected for cracks using ultrasonic inspection and loaded into a chain driven carriage mechanism (“Transfer Loader”). The egg is then normally transported to one of a plurality of packing machines by the aforementioned carriage mechanism. The particular packing machine to which any individual egg may be transported is determined by a computer. This process or elements thereof up to but not including the packing machine constitute (“Grading” and the “Grader”). The carriage mechanism typically consists of one or a plurality of chains, running the length of the Grader past all the packing machines in the horizontal plane (“Grader Chains”). The packing machines are usually configured with an egg flow perpendicular to the Grader Chain in the horizontal plane.

The egg industry widely uses Continuous Inkjet Printer technology (“CIJ Printers”) to print Size, Grade and Date information together with other information or images and logos on to the surface of an egg shell (“Data”) of a fresh egg travelling through an egg grading machine. The CIJ Printers are traditionally placed in a location on the production line that is responsible for grading the eggs and the site for such installation is chosen to minimize the number of CIJ Printers required for a given installation. CIJ Printers have typically been installed on the Grader Chain as near to the Transfer Loader as practical, and typically (although not always), prior to all the packing machines to which almost all eggs are later diverted.

As a consequence of the location, the CIJ Printer provides a relatively economic means of applying Data that limits the number of printing heads. Like most processing methods the execution of these installs represents a compromise of many factors, and the method described above has disadvantages which adversely affect the equipment, retailers, and consumers of eggs negatively. The negative elements of the known method described above include:

a) The CIJ Printer's print-head is installed inverted below the flow of eggs;

b) Egg debris or broken eggs can fall into the jetting mechanism of the inkjet printer causing downtime and impeding print quality;

c) The flow of ink is upward and therefore stray ink can fall backwards and result in downtime and maintenance issues;

d) The linear speed of the eggs as they pass the print-head is fast and therefore the amount of data is limited;

e) The linear speed of the eggs as they pass the print-head is fast and therefore the print quality achieved is typically poor quality;

f) The eggs usually travel in the Grader Chain clamped long ways and therefore the print applied to the eggshell is on the side of the egg in a print direction equal to the direction of egg travel (along the long axis of the egg) with such print being normally unreadable by a consumer without handling the eggs in the carton;
a. Handling the eggs in a carton can lead to contamination of the egg; and
b. Handling of the egg in the carton can lead to increased levels of breakage by consumers inspecting eggs in the retail store where they are sold;

g) A reasonable high proportion of eggs will have very poor or unreadable marks due to a combination of these factors; and

h) If the grader has a minor malfunction, an egg can be inadvertently diverted (or fall) from the Grader at an unplanned Packing Machine (i.e. not the one the computer had intended). Because the plurality of packing lanes often process multiple brands of eggs concurrently, if an egg has brand data printed on it, or size data printed on it, and incorrectly branded or sized egg appearing in the wrong carton can be a legal and public relations issue and can cause both consumer and retailer dissatisfaction.

It is known to use laser to mark indicia onto perishable products for the purpose of tracking their pedigree and/or integrity (e.g., using date codes and/or traceability data), as well as for allowing textual or graphical advertising messages to be disseminated via such products. An example of such a system for laser marking such information on shell eggs is described, for example, in U.S. Pat. No. 8,084,712 (“the '712 Patent”), issued Dec. 27, 2011 and assigned to TEN Media, LLC. The disclosure of the '712 Patent is incorporated by reference in its entirety.

The approach described in the '712 Patent is to laser mark eggs as they are conveyed at high speed during the grading process. Although this approach has proven effective for certain applications, the extremely high throughput of the grading machines, the lack of uniformity in moisture content of the surface of individual eggs during the grading process, and the significant amount of dust created during the laser marking process, among other things, have made it challenging to mark individual eggs with sufficient accuracy, reliability, and consistency for certain purposes. Examples of systems and methods for improving laser marking of shell eggs are described, for instance, in the following U.S. patents assigned to TEN Media, LLC: U.S. Pat. Nos. 8,499,718; 8,455,026; 8,657,098; 8,455,030; 8,823,758; and 8,715,767, the entire contents of each of which are incorporated herein by reference.

Further, a number of regulatory and customer requirements not only specify the contents of markings on products, such as eggs, but also the depth of the marking on the surface. As such, there is a need for a system and method to improve the reliability and quality of the printing approach used in the egg packing industry while preventing damage to the egg shells.

As with CIJ printers, Laser Marking equipment may have failures attributed to dust, dirt, egg material, and carton material. Laser-based printing devices often are installed in close proximity to an egg packing or food printing process. The distance between the optical lens assembly of the laser device and the food product being marked is such that preventative measures such as fume extraction and positive air cannot keep the lens clean for extended periods of time. In particular, during the cleaning cycles, which are an essential feature of food processing plants, the lens may be contacted by debris from food products such as broken eggs that mean the lens must be cleaned. Low skilled operators and operational pressure combine to render fouling of the Laser Marking equipment's lens during the cleaning process an inevitable occurrence and a high risk for both down-time, failed quality of image and early failure of systems. It is further desirable to print or otherwise mark an egg shell with advertising or sponsored messages while modifying the advertising or sponsored message for optimal printing on an egg shell. Such advertising or sponsored images are required to be of high and consistent quality, and fouling of the Laser Marking equipment's lens can cause significant degradation of image quality.

Thus, there is a need for protecting the lens when exposed to the harsh environment.

Typically, food product cartons are printed during packing with information related to the quality and source of the food product, the packing date, and other data. The cartons are typically printed in a hostile environment by cartridge-based inkjet technology. It is typical in the industry to cover such technology with polythene bags during cleanup and to suffer downtime due to failed print-head cartridges. The industry accommodates the lack of suitability for purpose of using this technology due to the convenience afforded by it. Further, the environmental conditions and low coefficient of heat associated with the technology and the lightweight print head cartridges render the technology vulnerable to water and changes in temperature. A carton printing system cover that addresses these and other problems is therefore needed.

### BRIEF SUMMARY

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with embodiments herein, the present disclosure includes a method and system for applying markings on a food product by applying a radiant energy to the food product in such a manner to form a permanent marking thereon. The markings include text and graphics, and can include an advertisement, a freshness date, a traceability date, or other types of relevant information, or any combination thereof. A laser is preferably employed as the radiant energy source. Desirably, the radiant energy is applied so as to leave much of the area of the food product unaffected so as to form contrast between the unaffected areas and the marking. The method preferably forms the markings on the food product while the product moves through a predetermined region of a food processing system. The performance or characteristics of the laser may be adjusted in response to selected characteristics of the food product in order to optimize the marking applied thereon. Further, the interaction of the laser with the food product may be monitored by any suitable means and the depth or other characteristics of the laser marking may be adjusted in response to such parameters.

In a preferred embodiment, the present disclosure includes a method and system for applying markings on an egg by applying a radiant energy source to the shell of the egg so as to cause discoloration of the egg shell to form a permanent marking. In a preferred embodiment, the markings are made by laser etching without applying a foreign material to the egg shell.

In accordance with embodiments herein, the present disclosure includes an apparatus for applying markings on food products that is operable in association with a food packing system that packages the food products. The apparatus comprises a radiant energy source located in proximity to the food packing system so that the radiant energy source can apply radiant energy to the food product and form markings thereon.

A preferred embodiment includes an apparatus for applying markings on eggs that is operable in association with an egg-handling machine that performs washing, candling, grading, and packing of eggs. The apparatus comprises a radiant energy source located in proximity to the egg-handling machine, so that the radiant energy source can apply radiant energy to the egg and form the markings. In a preferred embodiment, the egg has a marking applied thereon, wherein the marking is formed at least in part by discolored material on the egg shell. The egg may include the marking being formed entirely by discoloration of the material of the egg shell. The egg may also be raw or pasteurized or hard-boiled. The radiant energy may be applied by a laser. The markings may be formed by a generally stationary radiant energy source as the egg is transported past the source.

In some embodiments, the present disclosure provides a method and system for applying markings on food products, comprising conveying the food product to a marking station having at least one laser marking device configured to apply laser energy of sufficient intensity to etch indicia on the food product, and activating the laser device to apply laser energy to the food product and etch the indicia thereon. The indicia includes text and graphics, and can include an advertisement or other graphical image, a freshness date, a traceability data, or other types of relevant information, or any combination thereof. In a preferred embodiment, the food product is an egg, and the laser etches the indicia on the outer surface of the shell of the egg. The applied laser energy may ablate and melt the surface of the egg shell to an approximate depth that is within the range of about 8 to about 25 micrometers. The applied laser energy may ablate and melt the surface of the egg shell to an approximate depth that is within the range of about 1.5 to about 8 percent of the thickness of the egg shell.

In some embodiments, the present disclosure provides a Laser Marking equipment (or plurality thereof) that is mounted on a linear slide of a conveyor that moves parallel to the row of eggs located in cartons during the dwell time and moves perpendicular to the direction of the conveyor when printing data on the eggs. For the cleaning process to take place, safety covers that are a statutory requirement of the laser system must be removed. In some embodiments, there are laser shutters, which are a device that automatically closes when the safety covers for the laser system are removed. Typically the opening or removal of the safety covers activates a laser safety circuit which prevents laser radiation from being produced, but in the event of a failure of this system, the laser shutters provide a secondary purely mechanical mechanism for preventing accidental human access to laser radiation when the safety covers are opened. Additionally this shutter mechanism protects the lens whenever the safety cover is removed. Thus, when cleaning is in process, the lens is always protected from the above-identified debris and contamination.

In a preferred embodiment, the present disclosure provides the above-identified Laser Marking equipment (or plurality thereof), the installation and processing approach involving:
a) The Laser Marking equipment's print-head has to be installed above the row of eggs;
b) Egg debris or broken eggs cannot fall into the lens of the Laser Marking equipment and will not cause downtime or impede print quality;
c) The linear speed of the print head passing the eggs is well controlled and slower than the Grader Chain method and therefore the amount of data is less limited;
d) The linear speed of the laser source passing the eggs is well controlled and slower than the Grader Chain method and therefore the quality of print is higher than the grader chain method;
e) The eggs are in the carton and the print is on the consumer facing surface of the eggshell and readable by a consumer;
   a. A reduction in physical consumer handling of the eggs in a carton will reduce contamination of the egg; and
   b. A reduction in physical consumer handling of the eggs in a carton will reduce breakage by consumers inspecting eggs in the retail store where they are sold;
f) The eggs will contain clear readable print;
g) The egg is printed in the branded carton and therefore the need to match the eggs to their cartons is obviated and the risk of both consumer and retailer dissatisfaction is greatly reduced;
h) The egg has an increased change in color in response to the laser;
i) Reduced chipping of the egg shell in response to the laser; and
j) Increased speed in the laser printing on egg shells.

As mentioned, marks may be made on egg shells using laser-based or ink-based technology. Such marks may include text and images. The text may be used to indicate egg freshness. Companies may sponsor the egg freshness marking process, and in return the sponsor may choose images to be printed on the egg. Sponsors of egg freshness dating request a means to select the appropriate image and messaging to be marked on eggs. This laser mark sequences and sponsor specific cartons describe a method for selection of suitable images by the sponsor and allocation of those images to specific production locations, packaging types and egg types. In some circumstances multiple sponsors may wish to place marks on eggs within a single production batch. The laser mark sequences and sponsor-specific cartons describe a method for setup and selection of the requested sequences of images to mark on eggs. Sponsors may wish to package eggs in sponsor-specific packaging, and the laser mark sequences and sponsor-specific cartons also includes the means to ensure that the sponsor's selected marks on eggs match those on the sponsor-specific egg packaging.

But, unlike printing on paper, printing on eggs shells and on egg packaging imposes a series of challenges that are different from other image-creation processes that the sponsor typically uses (such as multi-color digital printing).

In accordance with the embodiments disclosed herein, a Thermal Inkjet Cartridge (TIJ) or other drop on demand print technology for printing on egg cartons may be housed in an environmentally protected assembly, such as a carton printing system cover, which provides both offline sealing that extends print head and ink life and during production provides superior thermal stability and mechanical print positioning relative to a substrate.

In accordance with the embodiments disclosed herein there are one or more laser printing assemblies with multiple positions, capable of lasing in three or more successive positions. Because each pair of laser printing assemblies is lasing only two eggs at once in a row of 6 eggs, this allows for simplified egg stabilizer fingers and associated mechanisms as well as simplified and more effective extraction piping. This configuration also allows for lasing in two successive positions thus again simplifying the stabilizer fingers and mechanisms and extraction piping due to only lasing three eggs or sets of eggs at once.

Still other advantages, aspects and features of the subject disclosure will become readily apparent to those skilled in the art from the following description wherein there is shown and described a preferred embodiment of the present disclosure, simply by way of illustration of one of the best modes best suited to carry out the subject disclosure. As it will be realized, the present disclosure is capable of other different embodiments and its several details are capable of modifications in various obvious aspects all without departing from the scope herein. Accordingly, the drawings and descriptions will be regarded as illustrative in nature and not as restrictive.

### BRIEF DESCRIPTION OF THE DRAWINGS

The accompanying drawings incorporated herein and forming a part of the specification illustrate the example embodiments.

FIG. 1 is a diagram depicting an egg bearing markings using method and apparatus embodiments of the present disclosure.

FIG. 2 is a diagram of another view of an egg bearing markings using method and apparatus embodiments of the present disclosure.

FIG. 3 is a diagram of another view of an egg bearing markings using method and apparatus embodiments of the present disclosure.

FIG. 4 is a diagram of a top view of an egg bearing markings using method and apparatus embodiments of the present disclosure.

FIG. 5 is a block diagram depicting portions of an egg-handling machine and particularly illustrating inline and offline operations.

FIG. 6 is a diagrammatic view depicting apparatus for performing an embodiment of the method of the present disclosure.

FIG. 7 is a diagrammatic view depicting apparatus for performing an embodiment of the method of the present disclosure.

FIG. 8 is a diagrammatic view depicting a laser printing assembly for performing an embodiment of the method of the present disclosure.

FIG. 9 illustrates an example of a computer system 900 upon which an example embodiment may be implemented.

FIG. 10 is an example flow diagram of laser marking on eggs with the apparatus as shown in FIGS. 6 and 7 in accordance with at least one embodiment of the present disclosure.

FIG. 11 is a diagram of the laser printing assembly of FIG. 6 in accordance with at least one embodiment of the present disclosure.

FIG. 12a is a diagram of a plurality of laser printing assemblies in accordance with at least one embodiment of the present disclosure.

FIG. 12b is a partially exploded view of a diagram of a plurality of laser printing assemblies in accordance with at least one embodiment of the present disclosure.

FIG. 12c is a diagram of a plurality of laser printing assemblies with extraction pipes over the conveyor that is part of an egg packing line in accordance with at least one embodiment of the present disclosure.

FIG. 13 is a diagram of the plurality of laser printing assemblies of FIG. 12a over the conveyor that is part of an egg packing line in accordance with the present disclosure.

FIG. 14a is a top view diagram and FIG. 14b is a perspective view of the laser sources with shutters in accordance with at least one embodiment of the present disclosure.

FIG. 14c is a front view diagram and FIG. 14d is a side view diagram of the laser sources with shutter of FIGS. 14a and 14b in accordance with at least one embodiment of the present disclosure.

FIG. 15 is another perspective view of the laser sources with the shutters of FIG. 14b in accordance with at least one embodiment of the present disclosure.

FIG. 16a is a top view diagram and 16b is a perspective view diagram of a portion of an egg processing machine depicting TIJ egg carton printers with protective covers in accordance with at least one embodiment of the present disclosure.

FIG. 17 a side-view diagram depicting TIJ egg carton printers with a protective cover in the ‘closed’ and ‘sealed’ position with its latching pin pressed against the lock feature by foam rubber compression, in accordance with at least one embodiment of the present disclosure.

FIG. 18 a side-view diagram depicting TIJ egg carton printers with a protective print head cover partially open, in accordance with at least one embodiment of the present disclosure.

FIG. 19 is a perspective-view diagram depicting TIJ egg carton printers with an example print cartridge with the print head cover latch in an open position and the print head cover partially open.

FIG. 20 is an example print cartridge with its cover back and open, hanging freely to allow for carton printing.

FIG. 21 is an example print cartridge with its cover back and open and its print head latch folded back.

FIG. 22 is an example print cartridge.

### DETAILED DESCRIPTION OF THE PREFERRED EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

In general, the embodiments herein provide methods and systems for optimizing laser markings on food products. Embodiments of the present disclosure are directed to an apparatus as well as a method for laser marking food products as they pass through a marking station, with the marking being carried out by lasers that are designed and configured to render text and graphic representations as the food products pass through the marking station. While reference is made herein to eggs in particular, it should be understood that this disclosure is directed to all food products in which a laser mark may be applied thereon. In the example embodiment, there is provided a method and system for applying markings on an egg by applying a radiant energy source to the shell of the egg so as to cause discoloration of the egg shell to form a permanent marking. However, it is to be appreciated that the embodiments of the claims herein are not limited in any way to the example embodiment, but rather are to be interpreted to cover applying markings to other suitable food products. That is, the embodiments herein can be applied to optimizing laser markings or indicia formed on any suitable food product.

It should be understood that the terms “marking” or “etching” as used herein are intended to mean that a laser is employed as a radiant energy source. The laser beam is applied to leave most of the egg shell unaffected so as to provide contrast between the unaffected areas and the marking. The laser beam either ablates and melts or heats and discolors the outer surface material from the egg shell. A significant benefit of the use of laser marking is that brown eggs have etched indicia that is a contrasting white color, while white eggs have etched indicia that is a contrasting dark brown color. The structural integrity of the egg shell is not affected because the etching by the beam only affects the outer approximately 5 to approximately 25 micrometers of the egg shell, which is approximately 1.5% to approximately 8% of the thickness of the egg shell.

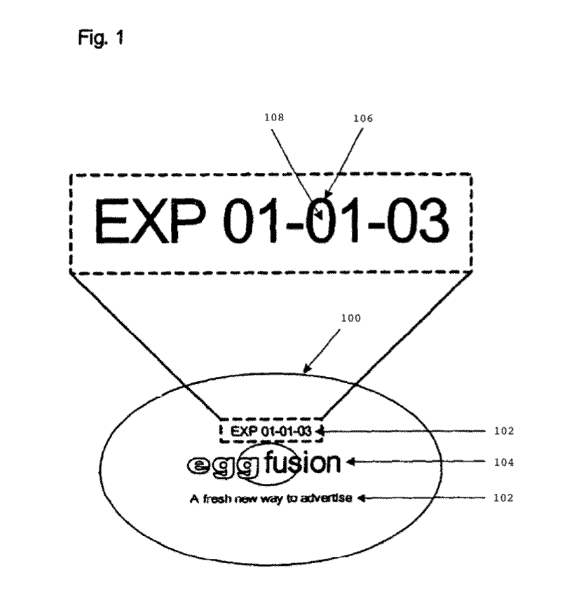

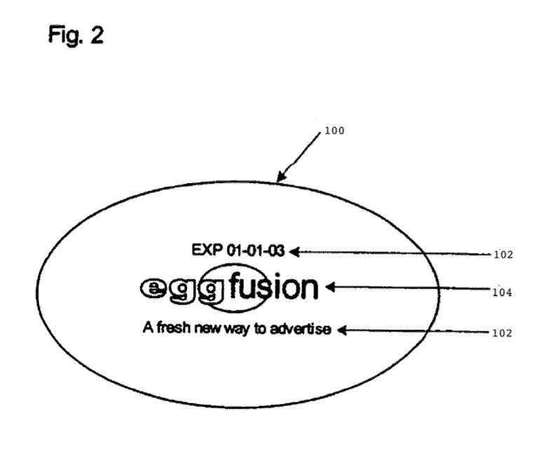

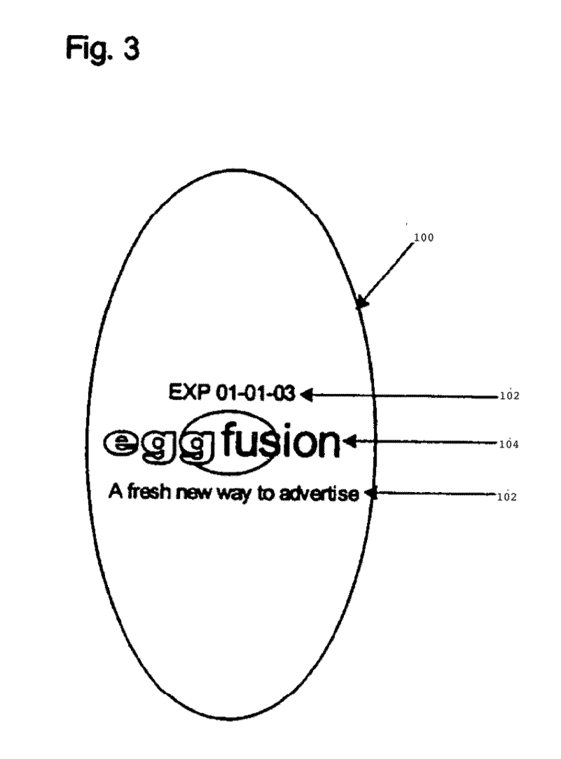

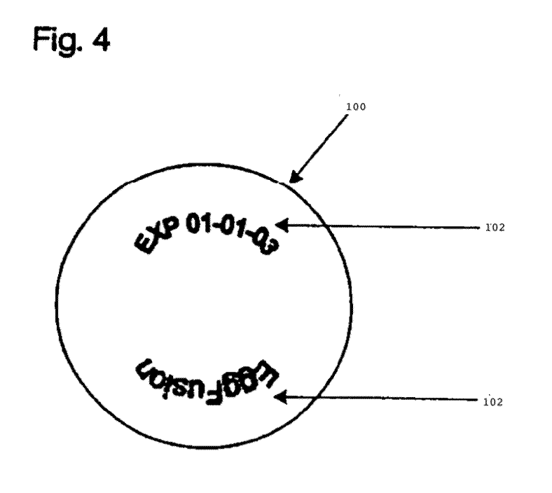

Referring to FIG. 1, an egg 100 is provided with markings or indicia, the markings include text 102 and graphics 104, and can include an advertisement or other graphical information, a freshness date, a traceability data, or other types of relevant information, or any combination thereof. The markings are formed by discoloring and/or ablating material of the shell to form text 102 and graphics 104, such as that which forms the number 0 as indicated at 106, and leaving other areas of the shell unaffected, such as the area inside the number 0, as indicated at 108. The discoloration and/or ablation may also be done variably so as to form a gradient of discoloration to form the graphics 104, or to create a variety of text 102, such as bold text, italic text, or any type of text or font. That is, some areas may be more discolored than others as, for example, by exposing them to radiant energy for a higher intensity or longer duration, including by making multiple passes, than other areas. The text and graphics may be applied horizontally (FIG. 2), vertically (FIG. 3), or on top (FIG. 4) of the egg.

Radiant energy as, for example, electromagnetic radiation such as visible, infrared, or ultraviolet light, can be used to discolor and/or ablate the egg shell. The radiant energy can be controlled to only discolor a targeted print area 106 of the egg shell. Some areas of the egg can be left unaffected 108 (see FIG. 1). The discoloration of the egg shell is easily viewable because of the contrast of the egg shell color 108 to the discoloration 106 from the radiant energy. The discoloration can be used to form indicia or marking information on the eggs. The discoloration to form text and graphics can be created generally concurrently by one or more radiant energy sources.

No foreign material is required to be added to the egg shell in order for the radiant energy to discolor the egg shell. Thus, no foreign material, such as ink or radiant energy sensitive material that could react with the radiant energy needs to be added to form a marking. The radiant energy is applied to the natural eggshell. Thus, the marking most desirably is formed solely by the effect of the radiant energy on the normally occurring materials of the eggshell itself. This provides several significant benefits. The egg can be properly represented to the consumer as a product with no additives or contaminants. Moreover, because it is not necessary to apply additional materials for purposes of the marking process, it is unnecessary to add the equipment needed to coat the egg with a foreign substance. This greatly simplifies the task of performing the process inline in the production environment of an existing high-speed egg handling apparatus. Additionally, the potentially significant cost of such additional materials is avoided.

In a method according to an embodiment of the present disclosure, a radiant energy source in proximity of an egg directs radiant energy towards the egg. Radiant energy source desirably includes a laser such as a C02 gas laser adapted to provide light at a wavelength between 9.0 and 10.7 microns, at a minimum of 25 watts, and a projected maximum of 200 watts radiated power, in a beam projected from approximately 100 mm at the surface of the egg. When operated in this power range, the beam ablates and melts the outer surface material from the egg shell. The structural integrity of the egg shell is not affected because the etching by the beam only affects the outer approximately 5 to approximately 25 micrometers of the egg shell, which is approximately 1.5% to approximately 8% of the thickness of the egg shell. The beam is directed onto those areas of the egg, which are to be discolored and turned on and off so as to provide a series of pulses, the beam being “on” for up to about 60 milliseconds during each pulse. During this pulsed actuation, the beam is swept across those areas of the egg surface, which are to be discolored. The sweeping motion may be performed in any manner which will provide the desired relative motion of the beam and the egg. Since the preferred embodiments will operate in association with an egg-handling machine which moves eggs at an extremely rapid speed, the beam must be rapidly moved to produce the desired indicia and also may compensate for the speed of movement of the eggs past the laser apparatus, which is preferably stationary. For example, the radiant energy source may include a beam-sweeping unit incorporating conventional optical elements such as movable or variable lenses, mirrors or prisms adapted to deflect the beam and to vary the deflection with time. Suitable radiant energy sources include, but are not limited to, Sealed CO2 Gas Lasers, Slow-flow CO2 Gas Lasers, TEA CO2 Mask Lasers, CO Gas Lasers, UV Gas Lasers, solid-state visible light lasers, and mid-IR Solid State Lasers. In other embodiments, the radiant energy source may be also be a YAG-type and/or fiber laser system, and may be coupled with a frequency multiplying optical element.

In a method according to an embodiment of the present disclosure, an egg moves through a portion of an egg-grading machine. An egg-grading machine grades the quality of the eggs, and may also transport the eggs towards a packaging machine. Egg-grading machines will move the egg along a path. Somewhere along the path, and preferably immediately before the eggs are packed, a predetermined region can be selected where the egg will pass through and radiant energy can form markings on the egg. Typically, egg-grading machines have calipers that hold the eggs at some point in the path of the egg-grading machine. The radiant energy source may be placed in proximity to this point when the eggs are held so that the radiant energy forms the markings on an egg as it passes through this predetermined region. This eliminates any need for a special apparatus to position the egg. In this way the method is performed inline with the egg-grading machine.

In another embodiment of the present disclosure, a radiant energy source may be placed in proximity of an existing egg-handling machine. Egg-handling machines includes any device or apparatus that will control the movement of an egg along a path, including egg-grading machines. The radiant energy source can be placed in proximity to the egg-handling machine so that the markings may be applied to the egg inline. The egg-handling machine moves an egg along a conveyor apparatus in a particular direction. A radiant energy source is placed in proximity to the conveyor apparatus such that radiant energy is directed towards the egg.

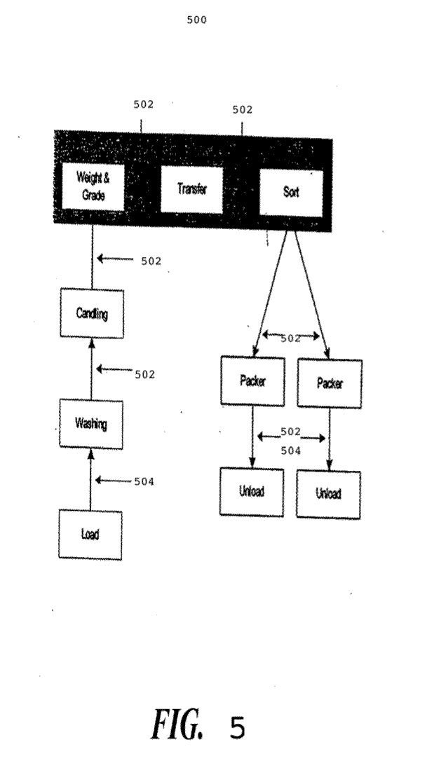

There are many variations of egg-handling machines. Most perform some common minimal basic functions. FIG. 5 is a block diagram outlining the basic functions of those machines. The eggs move through these machines 500 while these basic functions are performed, and a radiant energy source can be placed inline 502 or offline 504 in between many of these functions to perform a method of the present disclosure. The eggs are loaded into the machine. An offline procedure may be performed after this function. The eggs are then washed, after which an inline method may be performed. The eggs are candled, after which an inline method may be performed. The eggs move to the grading portion of the machine where they are weighted and graded, after which an inline method may be performed. The eggs are then transferred to a sorter, before which an inline method may be performed. The eggs are then sorted by grades and sizes, after which an inline method may be performed. The eggs are placed into a package, after which an inline method may be performed. An offline process 504 can be performed prior to the load processor and, typically involves human intervention or some other form of mechanical intervention alien to the egg-handling machine. In preferred embodiments of the present disclosure, the radiant energy source can be associated with an existing egg-handling machine without appreciably modifying the machine. The egg-handling machine preferably includes sensors or other suitable monitoring devices for monitoring the operational and environmental parameters of the egg-handling machine.

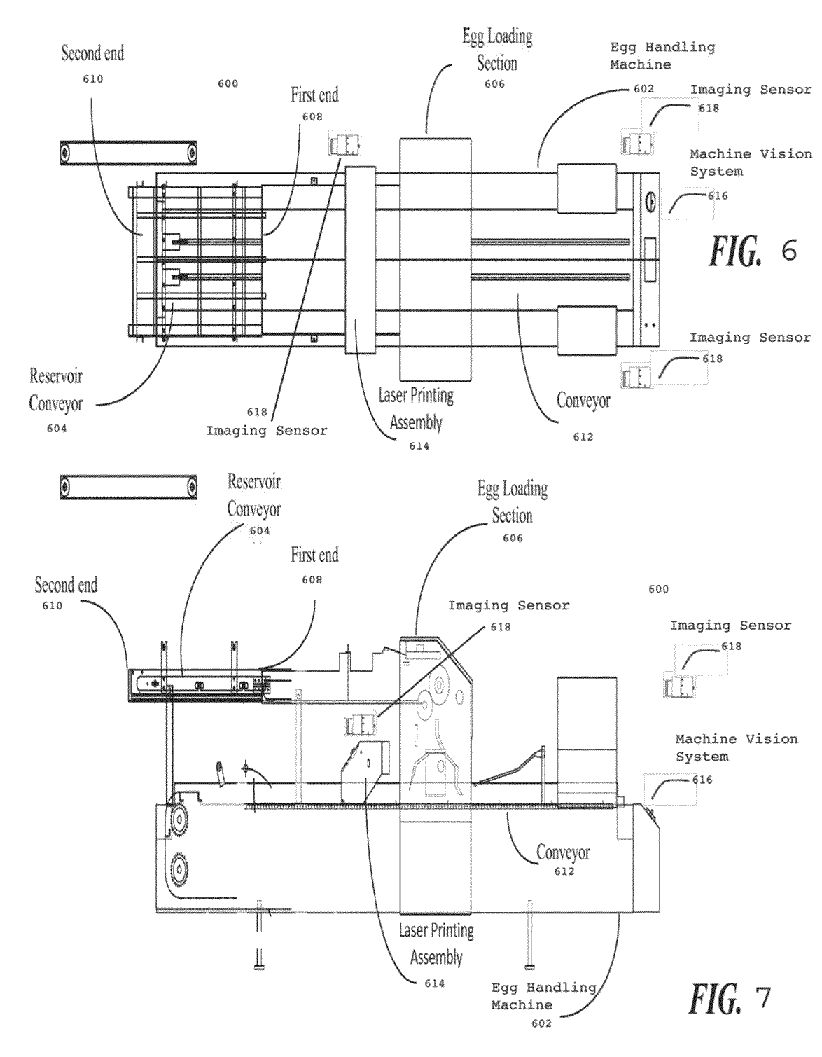

FIG. 6 illustrates a top-view of a system diagram of an example embodiment of an apparatus 600 that is operable in association with an egg-handling machine 602 that performs washing, candling, grading, and packing of eggs as discussed above. The apparatus includes at least one laser printing assembly 614 comprised of at least one laser source operable to apply laser markings on eggs. FIG. 7 illustrates a side view of the system diagram of an example embodiment of apparatus 600 that is operable in association with egg-handling machine 602. While reference is made herein to eggs in particular, it should be understood that the same principles and features may be applied to an apparatus for applying marks on other suitable food products.

A reservoir conveyor 604 is connected to an egg loading section 606 of the egg handling machine 602 at first end 608 and an egg grading machine (not shown) at second end 610. In an example operation, eggs are passed from the egg grading machine (not shown) to the reservoir conveyor 604 via the second end 610. The reservoir conveyor 604 then passes the eggs along the conveyor to the first end 608 and to then to the egg loading section 606. The egg loading section 606 then receives an egg package (not shown) along a conveyor 612 and then deposits a plurality of eggs into the egg package. The eggs are deposited in the egg package such that the egg package is open and at least a portion of each of the eggs is accessible. In most instances, at least a portion of the eggs extend above the open egg package. Typically the eggs do not travel continuously down the conveyor belt of conveyor 612. Instead as each set of eggs are placed in the egg package at the egg loading section 606, a pause in the conveyor belt of the conveyor 612 occurs. During this pause or dwell time, the at least one laser source in the laser printing assembly 614 prints data on at least one of the eggs in the open egg carton. Preferably, the at least one laser source prints data on each of the eggs in the open egg carton.

The laser printing assembly may be configured in various configurations depending on the markings to be applied onto the eggs and the egg processing speed required in different embodiments or environments. For example, in one embodiment, the laser printing assembly 614 may be situated at the side of the conveyor 612 at a position where a portion of the egg carton is located below the at least one laser source. In another embodiment, the at least one laser source or associated beam delivery or beam deflecting or beam focusing elements may be mounted on a linear slide in the laser printing assembly 614 that moves parallel to the row of eggs during the dwell time and perpendicular to the direction of the conveyor belt of the conveyor 612. Thus, the at least one laser source prints from above the eggs contained in the egg package. The information printed thereon includes text and graphics, and can include an advertisement, a freshness date, a traceability data, or other types of relevant information, or any combination thereof. In those embodiments in which the laser source prints from above the eggs, egg debris and/or broken eggs will not fall onto the laser source and therefore will not cause downtime or impede print quality.

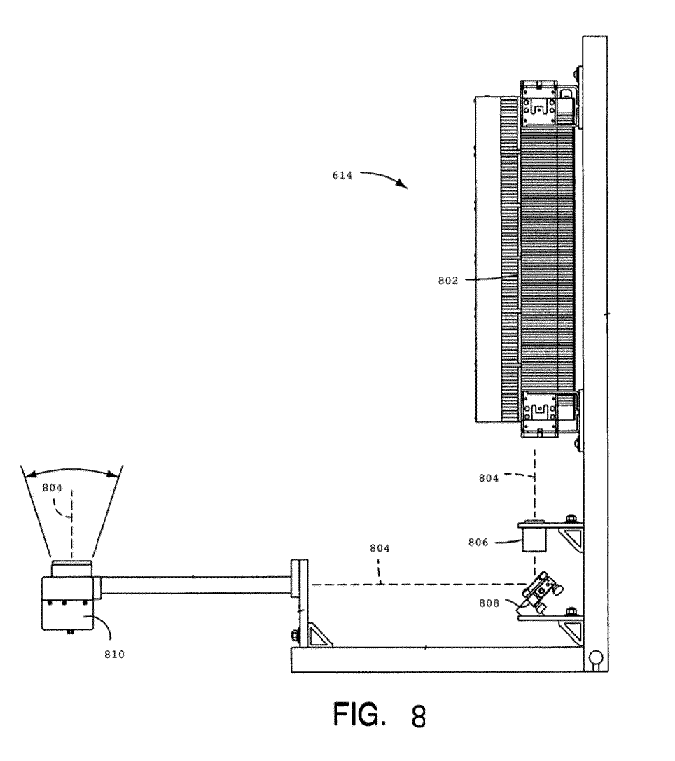

FIG. 8 is a diagram of one embodiment of the laser printing assembly 614 of FIGS. 6 and 7. The laser printing assembly 614 includes at least one laser source 802. The laser source 802 outputs a laser beam 804 that passes through a collimating and focusing lens 806, is then reflected off of mirror 808 to a galvanometer scanning head 810 that directs the laser beam to a specific location on the eggs passing thereunder. The laser printing assembly 614 may also include other components as necessary to interact with the apparatus 600 and apply the desired laser markings to the eggs. The laser printing assembly, which includes at least one laser source, preferably has vector scan and raster scan capability for applying the desired markings to the eggs. The laser printing assembly is in communication with an associated computer, controller, central processing unit, or the like (“computer system”) that controls the operation of the laser printing assembly and the at least one laser source contained therein.

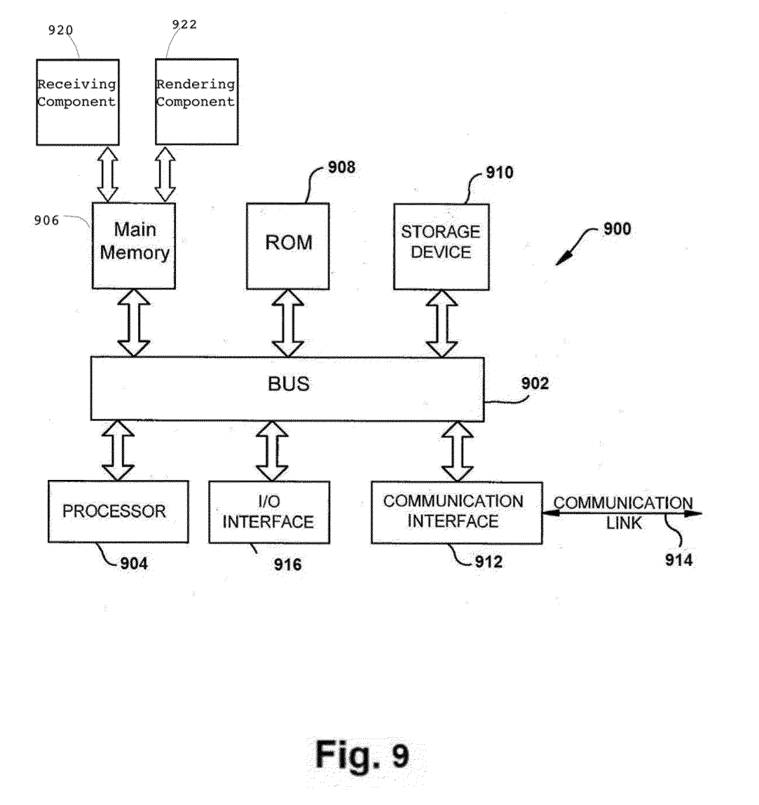

FIG. 9 illustrates an example of a computer system 900 upon which an example embodiment may be implemented. Computer system 900 is suitable for implementing the functionality of any embodiment of the apparatus 600 described herein in FIGS. 6 and 7.

Computer system 900 includes a bus 902 or other communication mechanism for communicating information and a processor 904 coupled with bus 902 for processing information. Computer system 900 also includes a main memory 906, such as random access memory (RAM) or other dynamic storage device coupled to bus 902 for storing information and instructions to be executed by processor 904. Main memory 906 also may be used for storing a temporary variable or other intermediate information during execution of instructions to be executed by processor 904. Computer system 900 further includes a read only memory (ROM) 908 or other static storage device coupled to bus 902 for storing static information and instructions for processor 904. A storage device 910, such as a magnetic disk, optical disk, SD memory and/or flash storage, is provided and coupled to bus 902 for storing information and instructions.

An aspect of the example embodiment is related to the use of computer system 900 to implement the method and system for applying laser markings to food products. According to an example embodiment, applying laser markings thereon are provided by computer system 900 in response to processor 904 executing one or more sequences of one or more instructions contained in main memory 906. Such instructions may be read into main memory 906 from another computer-readable medium, such as storage device 910. Execution of the sequence of instructions contained in main memory 906 causes processor 904 to perform the process steps described herein. One or more processors in a multi-processing arrangement may also be employed to execute the sequences of instructions contained in main memory 906. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 904 for execution. Such a medium may take many forms, including but not limited to non-volatile media, and volatile media. Non-volatile media include, for example, optical or magnetic disks, such as storage device 910. Volatile media include dynamic memory, such as main memory 906. As used herein, tangible media may include volatile and non-volatile media. Common forms of computer-readable media include, for example, floppy disk, a flexible disk, hard disk, magnetic cards, paper tape, any other physical medium with patterns of holes, a RAM, a PROM, an EPROM, a FLASHPROM, CD, DVD or any other memory chip or cartridge, or any other medium from which a computer can read.

Various forms of computer-readable media may be involved in carrying one or more sequences of one or more instructions to processor 904 for execution. For example, the instructions may initially be borne on a magnetic disk of a remote computer. The remote computer can load the instructions into its dynamic memory and send the instructions over a telephone line using a modem. A modem local to computer system 900 can receive the data on the telephone line and use an infrared transmitter to convert the data to an infrared signal. An infrared detector coupled to bus 902 can receive the data carried in the infrared signal and place the data on bus 902. Bus 902 carries the data to main memory 906 from which processor 904 retrieves and executes the instructions. The instructions received by main memory 906 may optionally be stored on storage device 910 either before or after execution by processor 904.

The computer system 900 also includes a communication interface 912 coupled to bus 902, for providing a two-way data communication coupling computer system 900 to communication link 914. Communication link 914 typically provides data communication to other networks or devices. Although the illustrated example has one communication interface 912 and one communication link 914, those skilled in the art should readily appreciate that this is for ease of illustration, as the example embodiments described herein may have any physically realizable number of communication interfaces 912, and/or communication links 914. The server 900 may further include at least one input/output interface 916 connected to the bus 902 and in data communication with one or more user interface devices, such as a mouse, keyboard, monitor/screen, etc. (not explicitly shown).

Notably, while the illustrative embodiment described below shows a single computer system as performing the functions described herein, it is understood that the computer system 900 may comprise, either as a single computer system or as a collection of computer systems, one or more memories, one or more processors, and one or more network interfaces (e.g., adapted to communicate traffic for a collaborative computing session and also traffic on a communication channel other than the collaborative computing session), etc., as may be appreciated by those skilled in the art.

The computer system 900 is operable to control the operation of the laser printing assembly and the at least one laser source contained therein. The computer system 900 is also operable to receive and/or generate data files containing vector and/or rector information for producing or generating movement of the laser beam to produce the desired markings. The computer system 900 is operable to control various parameters of the laser beam, such as power, spot size, spot area, laser speed, pulse width, pulse frequency, and/or modulation frequency. This enables optimization of laser performance which enhances resolution of the applied markings. The magnitude and character of these parameters may be associated with the vector and raster information and stored in memory and programmably varied according to the desired results.

The computer system 900 is preferably interconnected with other computer systems, sensors devices, and other devices associated with other machines, systems, networks, and the like that interact with the apparatus 600 as set forth in FIGS. 6 and 7. For example, the computer system 900 is preferably interconnected with the computer system that controls and monitors the operation of the egg handling machine 602. The computer system preferably receives environmental and product information from the egg-handling machine, such as wash water temperature, rinse water temperature, wash water pH values, egg origin and characteristic information, and the like. The computer system also preferably receives information from position sensors which monitor the operating status of all important moving components of the apparatus 600.

The computer system 900 receives and/or generates the data files for producing the text and/or graphics on the eggs via any suitable means. In one embodiment, the computer system 900 generates the data files based on content, image data, and/or other information (“content information”) received from an associated user, other computer system, device, network, or the like. In a preferred embodiment, the computer system includes a content information receiving component 920, which is any suitable software that enables the computer system 900 to receive content information. In a preferred embodiment, the computer system 900 further includes a content information rendering component 922, which is any suitable software that enables the computer system to rendering and/or formatting content information to be applied to the food products. It is to be understood that the content information rendering component 922 suitably renders, formats, or otherwise modifies the received content information for suitable marking onto the food products. As used herein, the phrase “render” may be used to describe such rendering, formatting, or modification of the content.

It is to be understood that content information receiving component 920 and content information rendering component 922 may suitably be implemented as logic operable to be executed by processor 904. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (“ASIC”), system on a chip (“SoC”), programmable system on a chip (“PSOC”), a programmable/programmed logic device, memory device containing instructions, or the like, or combinational logic embodied in hardware. Logic may also be fully embodied as software stored on a non-transitory, tangible medium which performs a described function when executed by a processor. Logic may suitably comprise one or more modules configured to perform one or more functions.

In a preferred embodiment, the computer system 900 receives the content information from an associated user, other computer system, device, network, or the like via the content information receiving component 922. Content information may be provided to the computer system through the input/output interface 916 via a suitable user interface device, through the communication interface 912 via the communication link 914, via a computer readable medium, or combinations thereof. For example, a user may input the desired content information via a user interface display associated with the computer system. The user may also transmit the content information electronically from a remote location, such as via a remote user interface or electronic mail. The user may also provide a computer readable medium having the content information stored thereon, wherein the content information stored therein accessed by the computer system for processing.

In one embodiment, the environmental information, product information, positional information, and other relevant processing information may be obtained using image capturing devices, machine-readable or human-readable sensors and identifiers, radio frequency identification transponders (RFID) or other transmitting sensors, time stamps or biometric identification, object recognition, texture definition, database management, and other software, data interface equipment consisting of serial, parallel, or network communication, binary data such as switches, gates, push buttons, current sensors, as well as additional forms of data input. The computer system 900 processes the obtained data and uses such data in the control and operation of the laser printing assembly as well as the associated egg-handling machine. By adjusting the depth or other characteristics of the laser marking applied thereon, a more consistent mark is achieved and variations of marking quality between different types of eggs, environments, and the like may be reduced and/or eliminated.

Egg origin and characteristics of the eggs on which the laser marking is to be applied, or the environmental or processing conditions to which the eggs are subject, may affect the quality of the mark to be applied thereon. These factors include, but are not limited to:

Shell composition (chemical);

Shell composition (mechanical features);

Shell thickness;

Percentage of cuticle remaining;

Shell strength;

Species of bird (chicken, ducks, turkeys, etc.);

Breed of bird;

Feed for bird;

Water source for chicken;

Barn temperature;

Molt cycle;

Age of bird;

Age of the egg

Color of egg;

Egg weight (individual and package)

Egg grade

Egg surface temperature at time of lasing;

Egg wetness at time of lasing;

Egg internal temperature at time of lasing;

Thermal conductive coefficient of egg shell;

Curvature of egg relative to the marking;

Egg washing process parameters;

Egg rinsing parameters;

Egg drying parameters;

Temperature and humidity in the packing facility;

Time of day;

Egg packaging parameters;

Peak temperature reached;

Degree of focus of the laser during marking;

Movement of egg during marking;

Temperature of air local to marking point;

Effectiveness of vacuum system.

Data relating to the characteristics associated with eggs or the processing or environmental conditions may be obtained by any suitable means. For example, the egg origin and characteristic information of the eggs may be obtained from the source providing the eggs, inspection/examination prior to the processing, data obtained from previous processing of similar types of eggs, data received or obtained by the computer system 900 during monitoring of the marking process, or any other means. Data relating to the environmental conditions, processing parameters, and the interaction of the laser with the egg shell may be obtained from previous processing of similar types of eggs, data received or obtained by the computer system 900 during monitoring of the marking process, or any other means. The computer system preferably stores the data in memory and uses such data as necessary in the control and operation of the laser printing assembly as well as in the control and operation of the egg-handling machine.

In accordance with an embodiment of the present disclosure, the performance or characteristics of the laser may be adjusted in response to selected characteristics of the food product in order to optimize the marking applied thereon. Further, the interaction of the laser with the food product may be monitored by any suitable means and the depth or other characteristics of the laser marking may be adjusted in response to such parameters. By adjusting the depth or other characteristics of the laser marking applied thereon, a more consistent mark is achieved and variations of marking quality between different types of eggs, environments, and the like may be reduced and/or eliminated.

Degradation of the cleanliness of the laser marking equipment's lens is a common cause, in many laser-based manufacturing processes, of reduced power and less predictable laser performance. Specifically localized reduction in light transmission through the lens will result in reduced power intensity at the surface of the product being processed with the laser system when the beam is directed to pass through that region of lower transmission, and variations in mark quality, depth of mark, and across the markable area will result. Therefore a system that results in less contamination of the lens, and results in less frequent cleaning being required for the lens, is advantageous for consistency in marking process performance.

The laser performance parameters may be suitably set or adjusted based on the egg characteristics, environmental conditions, processing conditions, interaction with the laser and the egg shell, and combinations thereof. In a preferred embodiment, the computer system 900 controls various parameters of the laser printing assembly and the at least one laser source to optimize the laser markings to be applied to the eggs. The parameters that may be set or adjusted include, but are not limited to:

Laser power;

Spot size;

Depth of field;

Speed of traverse of the laser beam over the surface of the object being marked;

Number of passes of the laser beam over the surface of the object;

Dwell-time between passes

Power settings within/between passes

Spot size of laser beam within/between passes;

Speed of traverse within/between passes;

Order of passes;

Dwell-time in corners of characters;

Configuration of character fonts;

Configuration of any graphical objects being marked;

Localized heat buildup;

Laser pulse frequency;

Laser wavelength.

The laser performance parameters may be set or adjusted prior to the laser marking process, during the laser marking process in response to data obtained during processing, or any combination thereof. The laser performance parameters may be set or adjusted per egg, per batch, per run, or any combination thereof. Preferably, the laser performance parameters are adjusted to optimize the laser marking applied thereon such that a more consistent marks is achieved and variations in marking quality are reduced and/or eliminated. In a preferred embodiment, the depth of the laser marking on the egg is adjusted to optimize the marking applied thereon as well as maintain the structural and biological integrity of the egg shell.

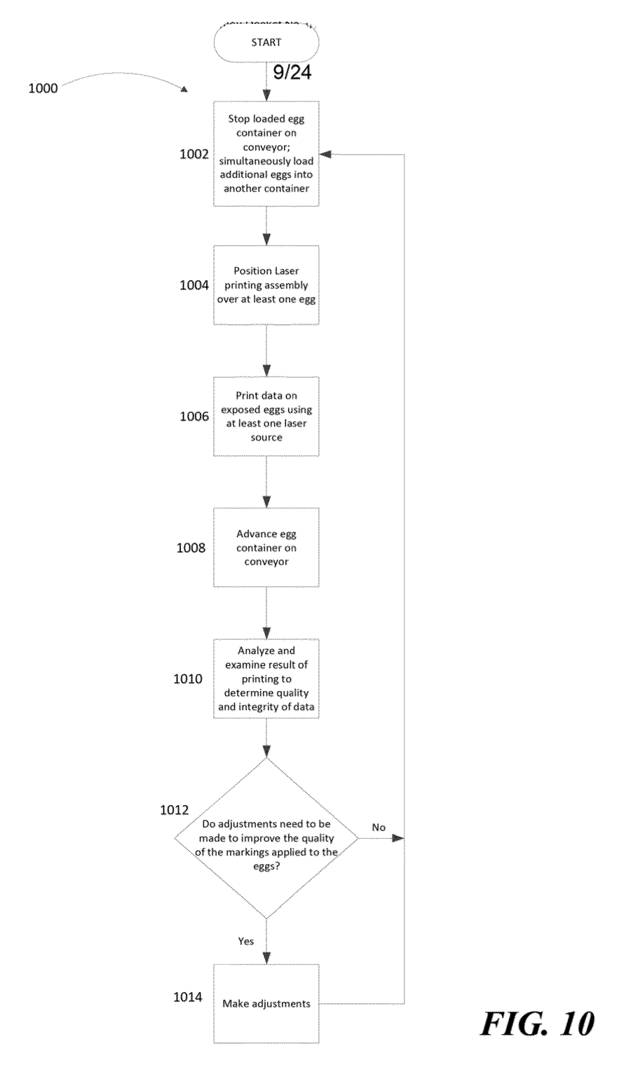

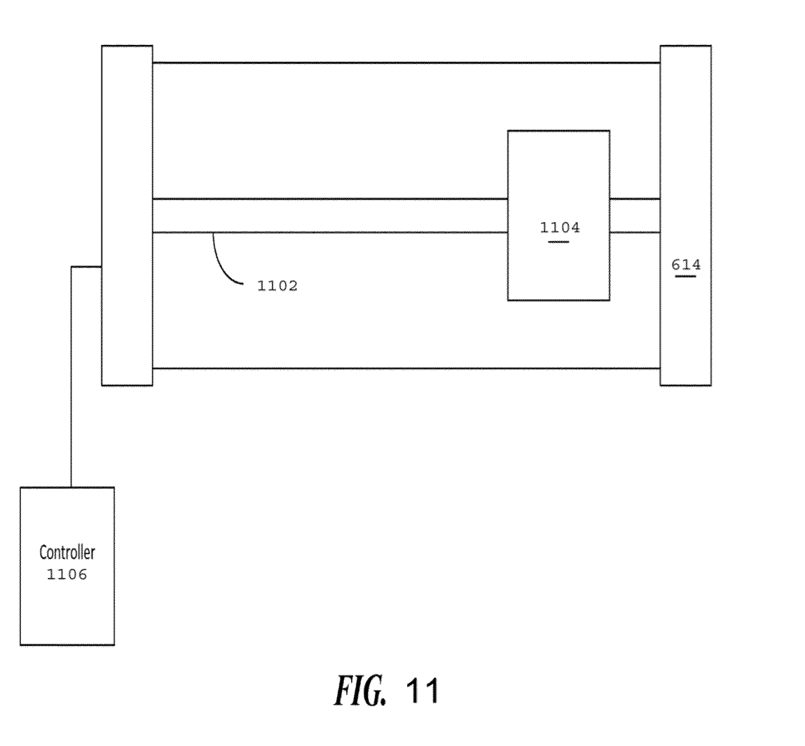

FIG. 10 is an example flow diagram 1000 of laser marking on eggs with the apparatus 600 as shown in FIGS. 6 and 7 in accordance with an example implementation. An egg carton stops for a predetermined period of time under the egg loading section 606 which loads the eggs into an egg container. Simultaneously while an egg container is being loaded by the egg loading section 606, a loaded egg container is stopped on the conveyor 612 under the laser printing assembly 614 as shown at 1002. The at least one laser source contained within the laser printing assembly 614 is positioned over at least one egg in the egg container as shown at 1004. The at least one laser source prints data onto the exposed eggs in accordance with the desired laser performance parameters as shown at 1006. The egg container is then advanced on the conveyor 612 as additional eggs are placed in an egg container by the egg loading section 606 as shown at 1008. At 1010, the eggs having data printed thereon are analyzed and examined as discussed above to determine the quality and integrity of the data printed thereon as well as the structural integrity of the eggs. In response to such analysis and examination, the computer system 900 or other suitable means determines if any of the laser performance parameters, environmental conditions, and/or processing conditions need to be adjusted to improve the quality of the markings applied to the eggs as shown at 1012. If it is determined that certain parameters and/or conditions need to be adjusted, such adjustments are made by any suitable means as shown at 1014. The next container of eggs is then processed according to such parameters and laser marking process continues again as shown at 1002. If it is determined that the parameters do not need adjusted, the laser marking continues again as shown at 1002.

The control of the laser performance parameters, in response to the environmental conditions, and the processing conditions by the computer system 900 results in optimized printing on the eggs such that a more consistent mark is achieved and variations in marking quality are reduced and/or eliminated. As the speed of the printing is so controlled, there are fewer restrictions on the amount of data to printed and the quality of the print is improved. The control of laser performance parameters, the environmental conditions, and process conditions results in clearer print, increased in change in color on the eggs, reduced chipping of the egg shells, and increased printing speed. In addition, as in some embodiments, the laser printing is performed from above the eggs, the data printed on the eggs is on the consumer facing surface of the egg shell and readable by the consumer. This results in a reduction of the need for physical handling of the eggs in the carton by the consumer, which reduces contamination and breakage. Further, as the eggs are suitably printed once already placed into their branded egg container, the need to match the eggs to their container is obviated, reducing consumer and retailer dissatisfaction.

In FIG. 11, a diagram of the laser printing assembly 614 of FIG. 6 in accordance with an embodiment of the present disclosure is depicted. The laser printing assembly 614 may have a rotating rod 1102 that rotates and causes at least one laser source 1104 to travel over eggs located in an egg container and be controlled by a controller 1106. It is noted that the laser source 1104 is located above the eggs. An alternate embodiment may use an ink printing system similarly arranged with the ink print head caused to travel across eggs located in an egg container, and may have ink supplied from above the print head. The ink may be supplied via a tube from a large reservoir or via cartridges coupled to the print head. The ink is preferably a non-toxic ink that will not harm humans if ingested.

The lasing system may be configured in various configurations depending on the marks sought and egg processing speed needed in different embodiments. A suitable ‘Material Handling System’ (“MHS”) and laser marking system together encompass a tool (“Lasing System”) that can be integrated into an existing packing plant and mark eggs at current production rates on eggs in a large variety of existing containers, and be cleaned with basic farm-friendly procedures to meet federal guidelines. Further, the system is safe to operate by existing farm personnel, in terms of mechanical, laser and environmental safety.

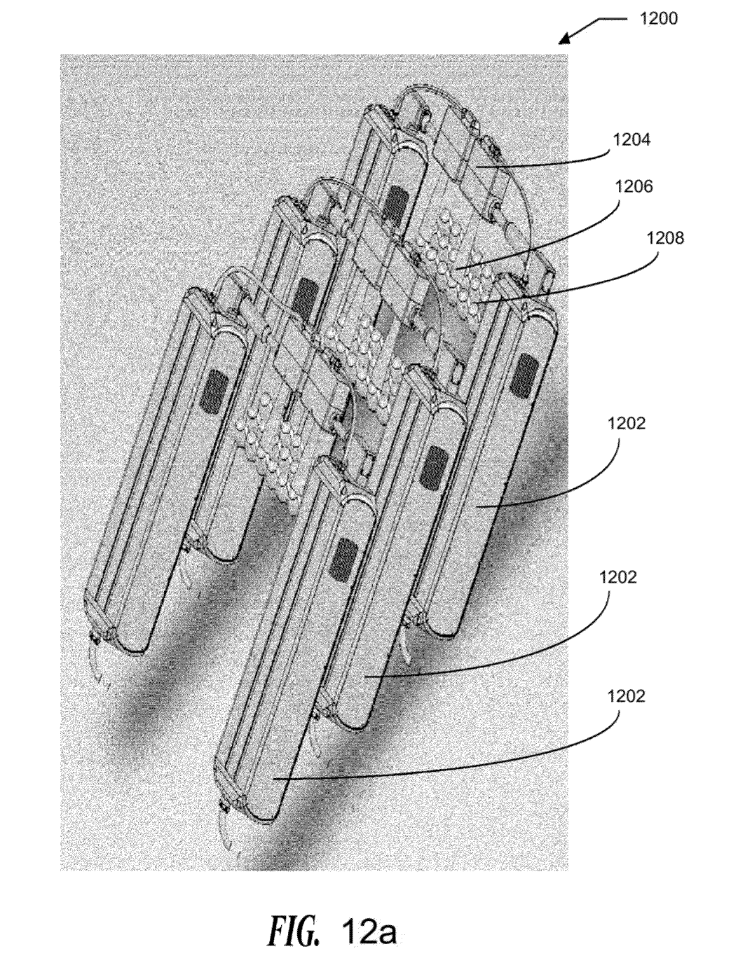

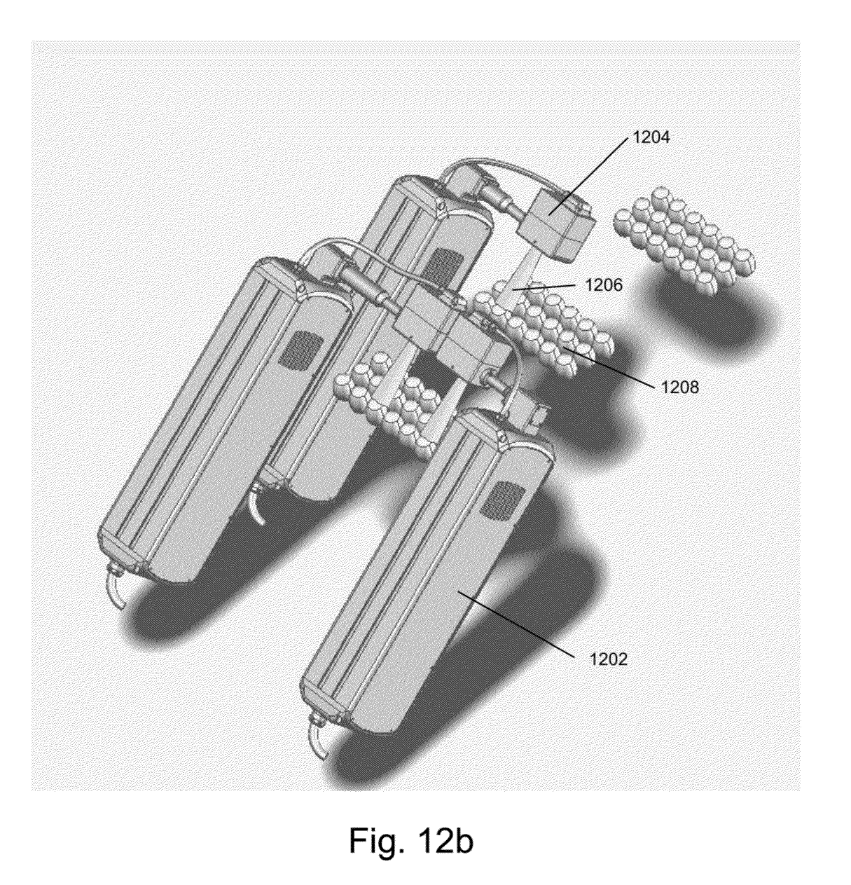

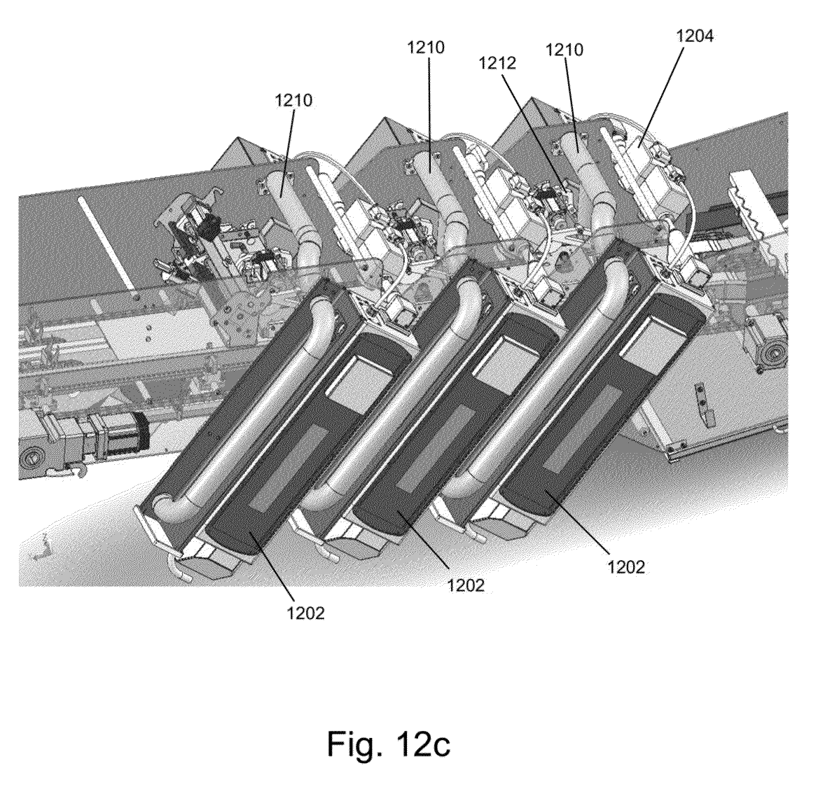

Turning to FIGS. 12a, 12b, and 12c, a diagram 1200 of a plurality of laser printing assemblies in accordance with another embodiment of the present disclosure is depicted. Eggs can be marked using light 1206 with one or more laser printing systems consisting of laser printing assemblies 1204 (which move the laser beams) that each have at least one laser source 1202. Eggs are placed into cartons 1208 using egg packing machines and the cartons are left unclosed. The Lasing System provides a Material Handling System (MHS) located after the egg packing machine. The unclosed egg cartons are passed to the “MHS” which includes laser marking systems, arranged to mark each of the eggs in the open cartons as they travel along a conveyor.

The laser printing assemblies 1204 enable lasing a single carton in multiple locations. In some embodiments, there are one or more laser printing assemblies 1204 with multiple positions, capable of lasing in three or more successive positions. Because each pair of laser printing assemblies 1204 is lasing only two eggs at once in a row of 6 eggs, this allows for simplified stabilizer fingers and mechanisms 1212 as well as extraction piping 1210 as shown in FIG. 12c. This configuration also allows for lasing in two successive positions thus again simplifying the stabilizer fingers and mechanisms and extraction piping 1210 due to only lasing three eggs or sets of eggs at once. The three sets of piping are connected to a central vacuum manifold which is in turn connected to a vacuum system (which can be local within the MHS or external, and can serve one or more MHS systems at a processing location). The inlet to each pipe is located centrally between the two eggs being lased. This provides even airflow over the area being marked, such airflow removing the particles and odorous smoke generated during the lasing process. In this embodiment, the laser printing assemblies can be configured to lasing two eggs from each laser, requiring only three lasers in either 3-across, 2+1 or 1+1+1 configuration. The laser printing assemblies can also be configured to lase two eggs each in two or three positions, making the system easier to service as all the laser printing assemblies can be located on only the more accessible side of the lasing system. Alternatively, they may be configured to lase in two or three positions, using common spare parts between positions, or to lasing in two or three positions, using standard laser equipment. Similarly, the laser assemblies can be configured to allow the lasing conveyor to accommodate 12-packs, 18-packs, 24-packs, 30-packs, 36-packs, and 20-packs, manufactured in cardboard, foam, plastic, and including other special carton configurations such as Jumbos, and double-six cartons.

The multiple-position designs result in no reduction in system throughput rate, compared with lasing all six eggs in one position. Another advantage of these embodiments is that it allows for multiple distinct locations of the extraction piping 1210 thus allowing for the extraction of dust volume created by the lasing, which eases system design and allows for greater efficiency in removing dust volume.

In some embodiments, the mounts for the laser sources 1202 have quick-release using keyholes and pins. Focus adjustment can be accommodated through pin position. A preferred embodiment has one keyhole pair slightly longer, allowing one pair of pins to be engaged first, simplifying the fitting and removal processes so that there is no need to simultaneously align 4 tightly-toleranced pins into matching slots in the MHS.

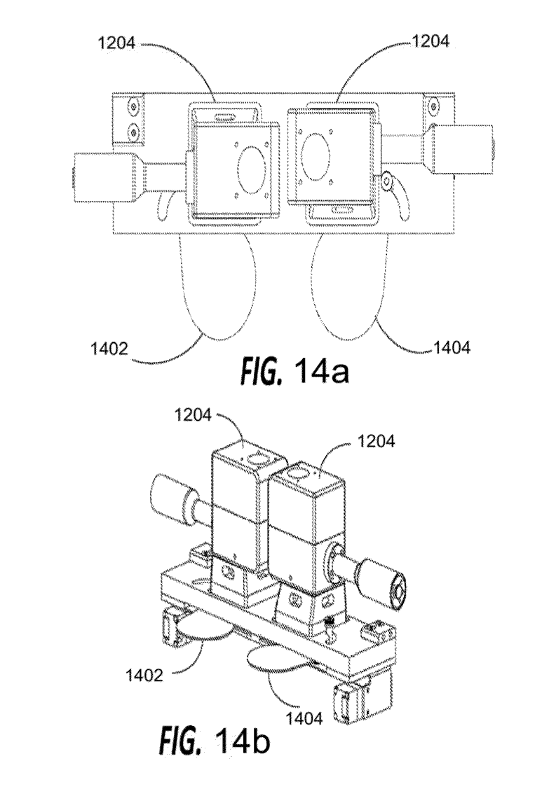

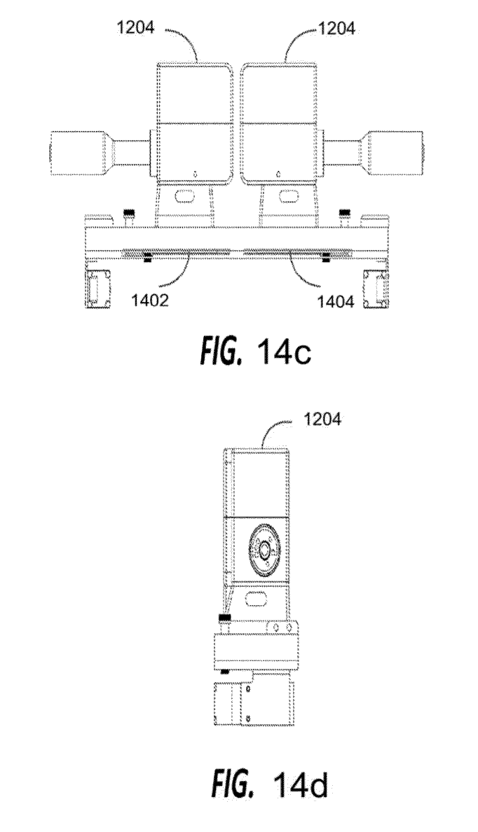

In some embodiments, the extraction piping 1210 is removable for easier and more effective cleaning. The extraction hood may be quick-release for easy cleaning and to allow access to the eggs underneath if needed. In some embodiments, the extraction hoods activate the laser shutters, discussed in detail with respect to FIGS. 14a through 16, and include safety switches to shut down the laser if extraction hoods are not present. Without adequate extraction in operation, byproducts of marking, such as dirt and odorous smoke, can remain in the area of marking. Such dust and debris may fall into the food products passing below, thereby risking consumer and retailer dissatisfaction. A local buildup of debris and smoke between the laser assembly's lens and the object being marked, can result in less power intensity at the product surface, in turn resulting in lower quality and less consistent marking. The safety switches may also prevent lasing into the laser shutter cover plates, which may prevent the plates and surrounding mechanism from overheating due to the heating effect of the laser beam on the plate when the plate blocks the laser beam.

In some embodiments, the lasing conveyor is servo controlled for optimum motion-speed to accommodate for acceleration and jerk to eliminate the possibility of damage to the eggs and cartons. In some embodiments the lasing conveyor motion is coordinated with the stabilizer fingers 1212 to optimize the timing of the laser movement relative to the lasing conveyor and eggs. Thus, the Lasing conveyor motion is coordinated with the laser firing process for optimum timing. This can be accomplished via the methods discussed in detail in connection with FIG. 9 in which conditions and output are monitored and optimized. By utilizing servo control, the eggs can be positioned most advantageously for marking by the laser system to generate consistent, high-quality marks.

In some embodiments, the lasing conveyor motion is coordinated in the same manner with the infeed system, which transports and orients the egg cartons between the packer and the lasing conveyor, for optimum total system efficiency. The lasing conveyor motion may also be coordinated with the closing conveyor for optimum total system efficiency.

In still other embodiments, a vision station can be mounted above the lasing conveyor, able to take photos and analyze results during the stationary egg/carton time. The data from the vision system can be analyzed according to the methods disclosed with respect to FIG. 9 as well as other methods known in the art or discussed in patents and applications assigned to TEN Media, LLC. Such a configuration simplifies the egg processing with a stationary object. As discussed above, such vision processing while eggs are stationary allows decisions on which egg column to inspect next—for example a failed read or poor mark (Zed) on one column could require that the next egg in that column be photographed and analyzed, instead of moving always to the next column sequence. In certain embodiments the vision system may detect a degradation in marking performance, whether local to a specific laser assembly or more widely across many laser assemblies in a food processing facility. This degradation can be analyzed to determine if a contaminated lens, or one of several other possible failure modes, is a possible cause of the observed and analyzed degradation.

In some embodiments, wiring for the laser assemblies can be above the bed of the conveyor, eliminating trapping in moving parts, easing cleanup of broken eggs. In some embodiments, the wiring has quick-disconnect features on both external ends to improve serviceability. The assemblies may also contain sliding electrical panels to aid in serviceability, as they would allow technicians to maintain a safe working distance away from panels.

In some embodiments, there exists an embedded extraction system, which includes the extraction piping 1210 and which eliminates the need for complex and expensive piping. It should be noted that the configuration of the laser sources and laser printing assemblies allows for either a right or left-handed Lasing System configuration from a single design.

In some embodiments, laser beam-blocks are positions underneath the conveyor in the beam path of each laser for the purpose of preventing stray laser light from escaping and to provide burn-through protection. System covers may also be present to provide machinery safety guarding and laser safety guarding in one device.

In some embodiments according to the present disclosure, there is an open-frame conveyor design that is formed using UHMW guides and chains, which facilitates ready cleaning compared with traditional bed conveyors. Traditional conveyors have flat plates with chains running along grooves. As a result, the plate can accumulate debris, such as eggshell fragments and broken eggs. Additional cartons may contact this debris becoming sullied and unusable. With the open-frame conveyor according to some embodiments of the present disclosure, debris falls away from cartons and does not foul additional cartons. Thus, while it is difficult to clean under the large flat plate design, the design in the present disclosure is open allowing ready access to otherwise difficult to access parts.

According to some embodiments of the present disclosure, gearboxes are mounted directly in the side frames, providing bearings, meaning no couplings or similar devices are needed to transmit power. Couplings can introduce backlash, which reduces the effectiveness of the servo controls. Right angle gear boxes may be used connected to the shaft via any kind of suitable coupling known in the art, obviating the need for a separate bearing because the gear shaft has a bearing already integral to the gearbox.

In some embodiments, the conveyor and lasing system is separate from the conveyor, lasing system and packer controls, and is configurable for different packer and outfeed heights via simple reconfiguration of conveyor angles.

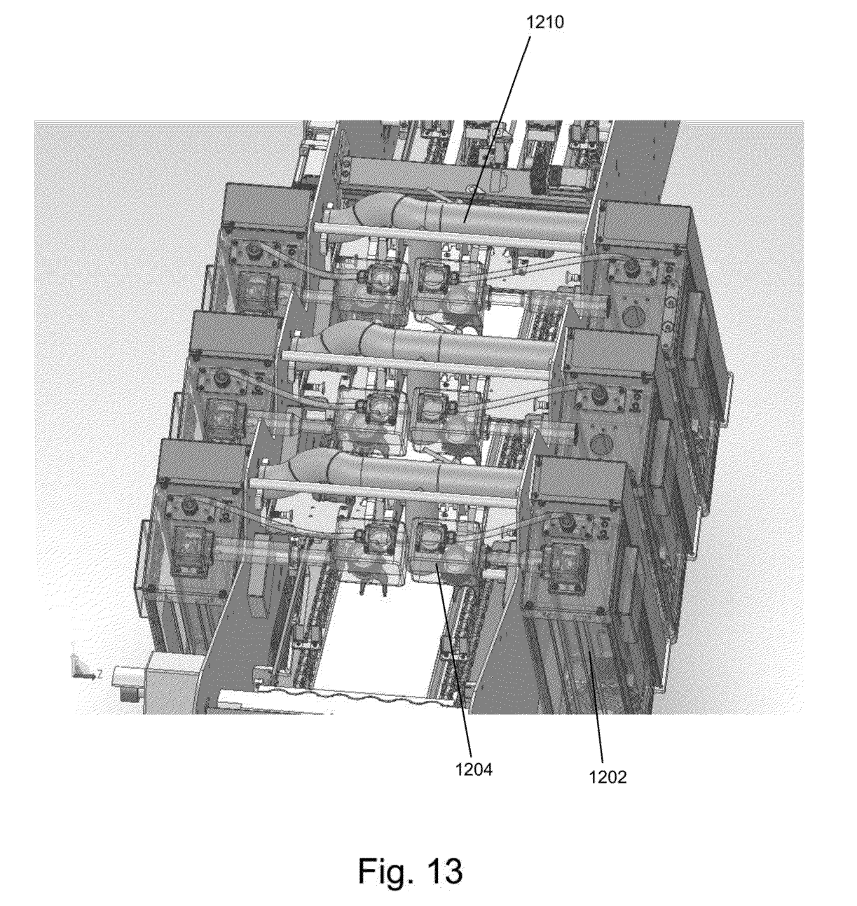

In FIG. 13 a diagram of the plurality of laser printing assemblies 1204 of FIGS. 12a-12c with laser sources 1202 over a conveyor that is part of an egg packing line that has an egg packer in accordance with the present disclosure is depicted. As seen, the plurality of laser printing assemblies 1204 straddles the conveyor and is controlled by a processor or controller. The laser printing assemblies may be retrofitted into egg packing lines in a position on the line where space is available after eggs have been placed into egg contains. As previously described. The laser sources, such as 1202 may be controlled by the controller or processor and printing/etching of the egg shell optimized based on a plurality of parameters.

Turning to FIGS. 14a, a top view diagram, and 14b, a perspective view diagram, of the laser printing assemblies 1204 with shutters 1402 and 1404 in accordance with the present disclosure are depicted. The shutters 1402 and 1404 are shown in a first or open position during operation of the laser printing assemblies 1204. When the lens needs protection, such as during cleaning of the laser head, the shutter 1402 and 1404 is placed in a second or closed position as shown in FIG. 14a is a front view diagram and 14b side view diagram of the laser printing assemblies 1204. Thus, the shutters provide a safety shutter mechanism for preventing accidental laser beam escape when guards are removed to facilitate cleaning processes, in addition to protecting the lens during such cleaning.

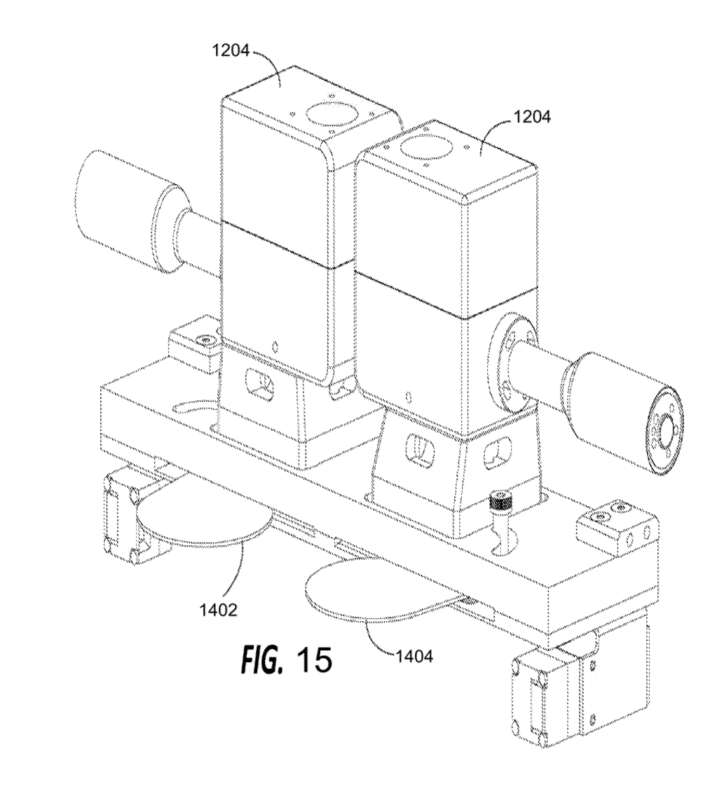

The shutters 1402 and 1404 may be sized to allow the full beam path, including optical configurations allowing the marking of 2 eggs with a single laser printing system when in the open position. The actuation of the shutters 1402 and 1404 may be accomplished by using only pins and rotation about a shaft, using a spring return with gravity assist for closing. Actuation around a shaft simplifies bearings and ensures the shutter is maintained parallel to the tight slot required for laser safety. As shown in FIGS. 14a, 14b, 14c, 14d, and 15 the laser shutters may be arranged in pairs, mounted in one single block. Additionally, some embodiments the shutter 1402 and 1404 components may be manufactured using black anodized aluminum to best absorb any stray laser beams.

An air purge for the lens may be provided via vacuum and slots allowing air into the low pressure area. The air purge approach forces air away from the lens, assisting in moving any debris resulting from laser marking away from the sensitive lens surface. In an alternate embodiment, the air purge may be provided using pressurized air and in such embodiments air may also be passed across the surface of the lens.

In yet another embodiment, a secondary protective lens in the safety cover may protect the lens from debris during lasing process. The secondary lens may be affixed to the laser system's primary lens, or may be affixed to the guard which can be removed for access and cleaning. The shutters may prevent access to the laser beam by fingers or eyes from above the guarded area. In yet another embodiment, a secondary protective lens in the safety cover may protect the lens from debris during lasing process. The secondary lens may be affixed to the laser system's primary lens, or may be affixed to the guard which can be removed for access and cleaning. The shutters may prevent access to the laser beam by fingers or eyes from above the guarded area.

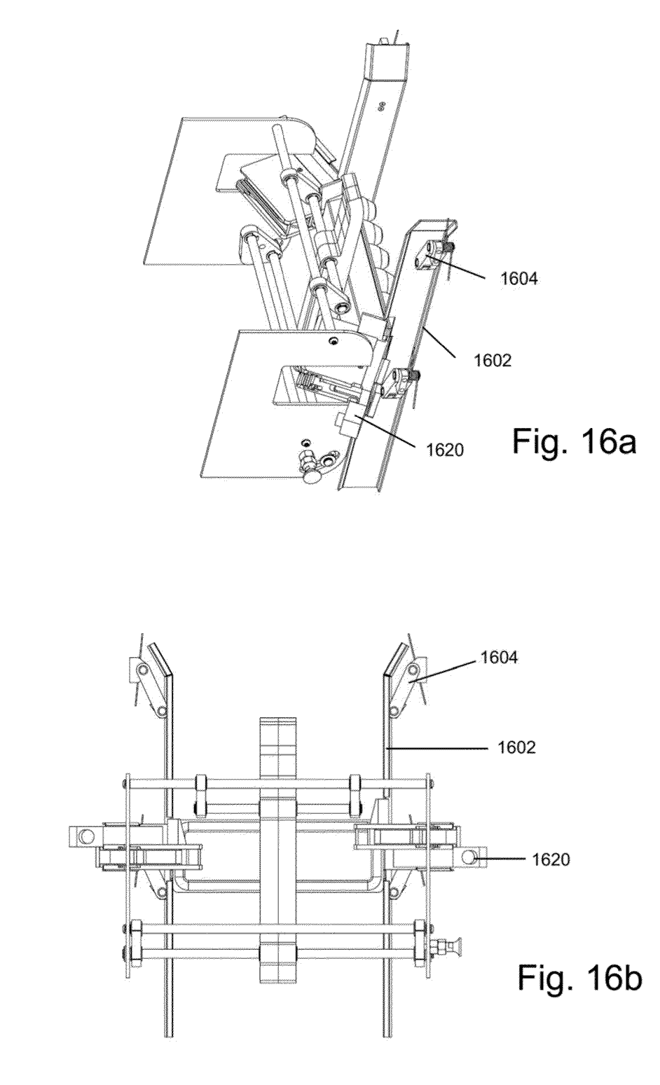

Regarding FIGS. 16a and 16b, one embodiment of the present disclosure is shown. In this embodiment, the carton marking system is situated within the carton closing system. There are two distancing railings 1602 situated on both sides of the conveyor chain (not shown), parallel to the path of motion of the conveyor chain 1606. The distancing railings 1602 taper away from the conveyance chain 1606 at the point of entry. The distancing railings 1602 are attached to spring elements 1604 which push the distancing railings 1602 towards the conveyance chain 1606. As such, when egg cartons are advanced through the carton marking system, the egg cartons first make contact with the tapered ends of the distancing railings 1602. During this process, the distancing railings 1602 are pushed outwards with the springs 1604 providing a gentle force on the egg cartons thereby helping centering the egg cartons on the conveyance chain 1606 and holding the egg cartons so that the optimal distance to the print cartridge is maintained for optimal print quality of information on one or both sides of the carton.

In an alternate embodiment, a laser system is used to mark the egg cartons rather than inkjet cartridges.

Attached to both distancing railings 1602 are thermal ink jet cartridges 1610 (not pictured in FIGS. 16a and 16b but discussed in more detail below) enclosed in a carton marker cover 1620 (discussed in more detail below). These thermal inkjet cartridges 1610 are attached in such a manner that the printing face 1612 of the thermal ink jet cartridges 1610 are roughly parallel to the surface of the carton lid to be marked. Furthermore, the print heads 1612 are situated such that there is a distance between the print head and carton surface to be marked. Because the thermal ink jet print cartridges are directly connected to the distancing railings 1602, the thermal ink jet print heads are consistently in an optimal position regardless of the type of egg carton being processed. In addition, because the print head is at an optimal distance from the surface to be marked, variations in the egg carton which may cause the surface to no longer be parallel with the print heads 1612 are still within the tolerances of acceptable print quality. It can be seen that the carton printing system is in close proximity to the carton, which provides high quality print but also leaves the sensitive printing surface close to areas where carton and egg debris can accumulate.

In one embodiment, the carton marking process occurs while the egg carton is still being held down by carton lid hold-down bars 1628. This configuration ensures that the carton lids remain closed during the carton marking process. The closing system is not pictures and precedes the carton marking system. In addition, the use of carton lid hold-down bars also provides the additional benefit of allowing independent timing between the closer system and the carton marking system. Furthermore, carton lid hold-down bars ensure that the egg cartons are moving at the same speed as the cleats of the conveyor system. Since the egg cartons are moving at a consistent speed throughout the process, there is no need for an encoder to ensure accurate print width.

Due to the harsh environment that a carton marking system operates in, it is advantageous to protect the cartridge, such as an inkjet cartridge 1610 of the above mentioned embodiment, of the carton marking system. Currently, the normal business practice is to cover the cartridges with polythene bags while the entire system is being cleaned. This can cause failures of cartridges especially due to failures with print heads and electrical contacts. In addition, failures may occur during operation due to moisture and changes in temperature.

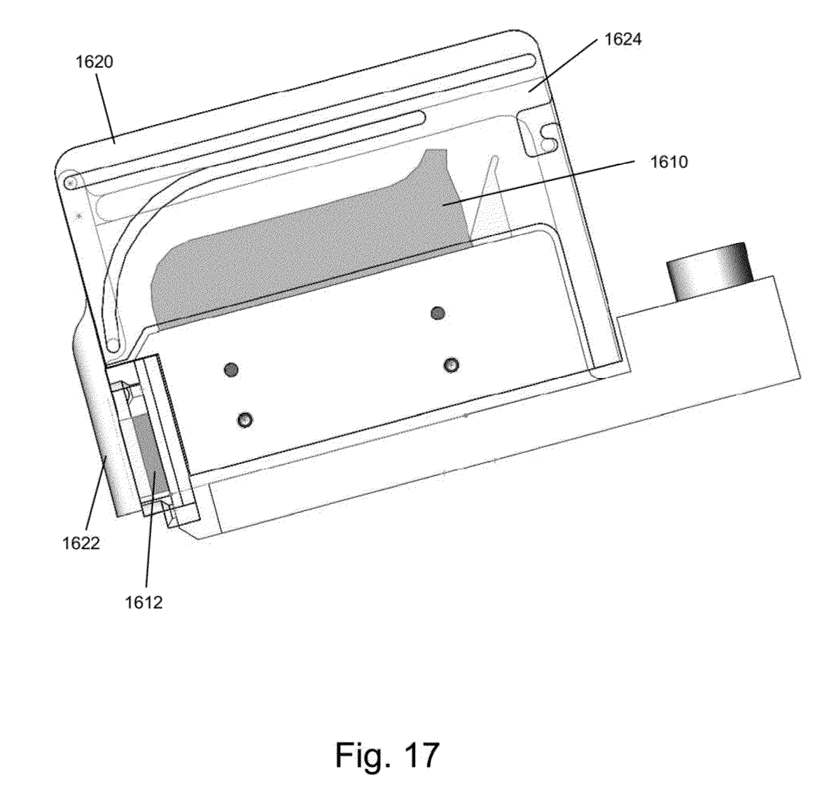

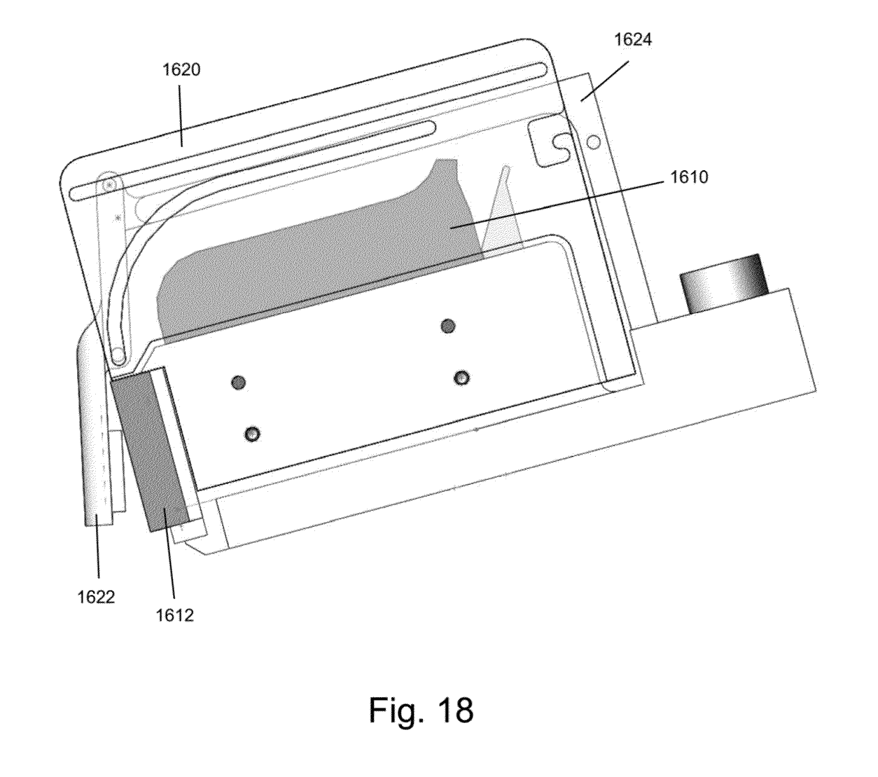

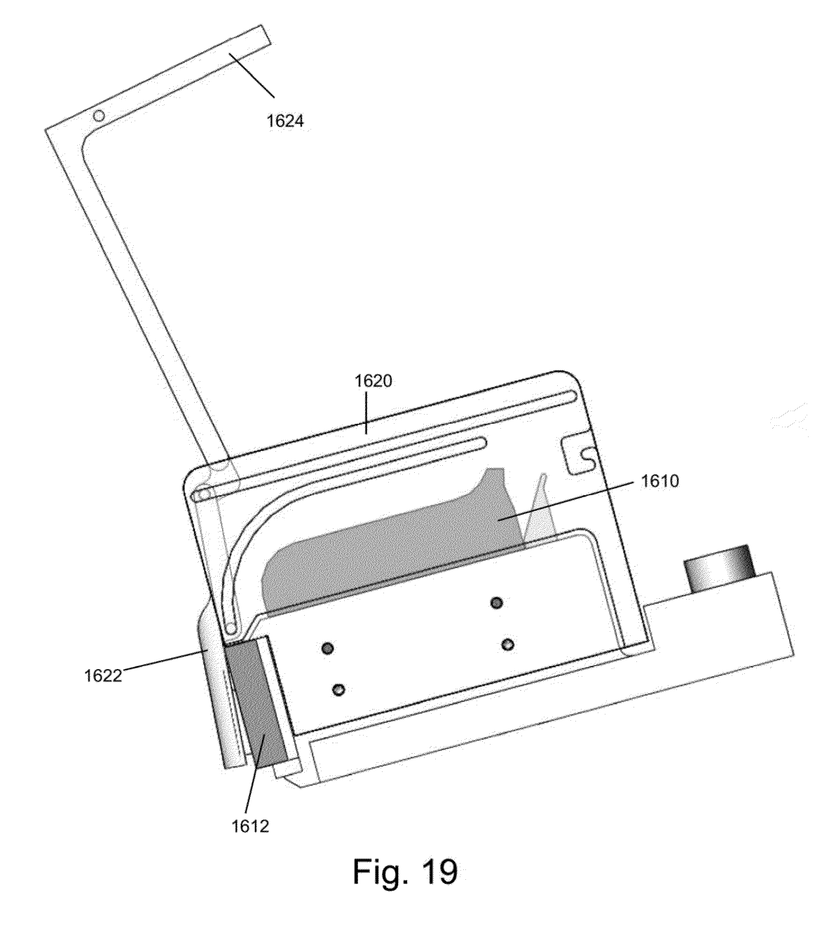

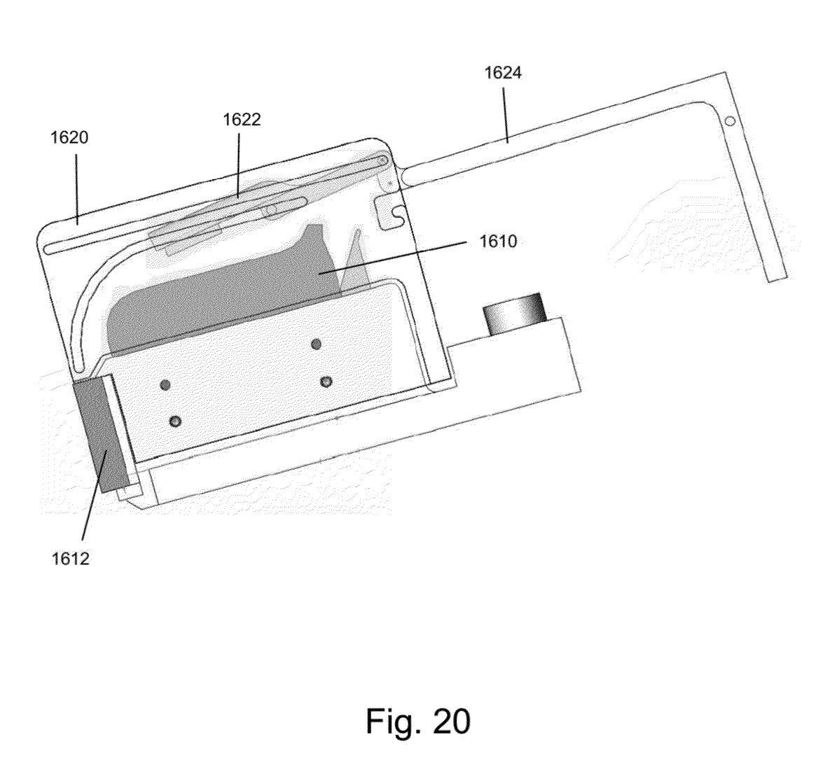

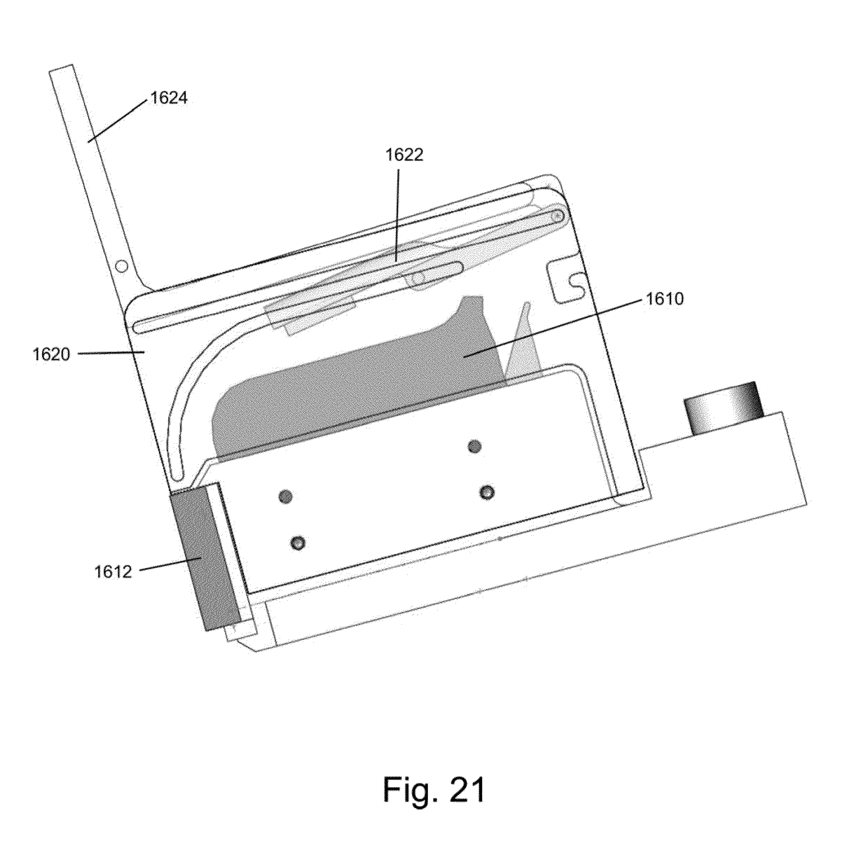

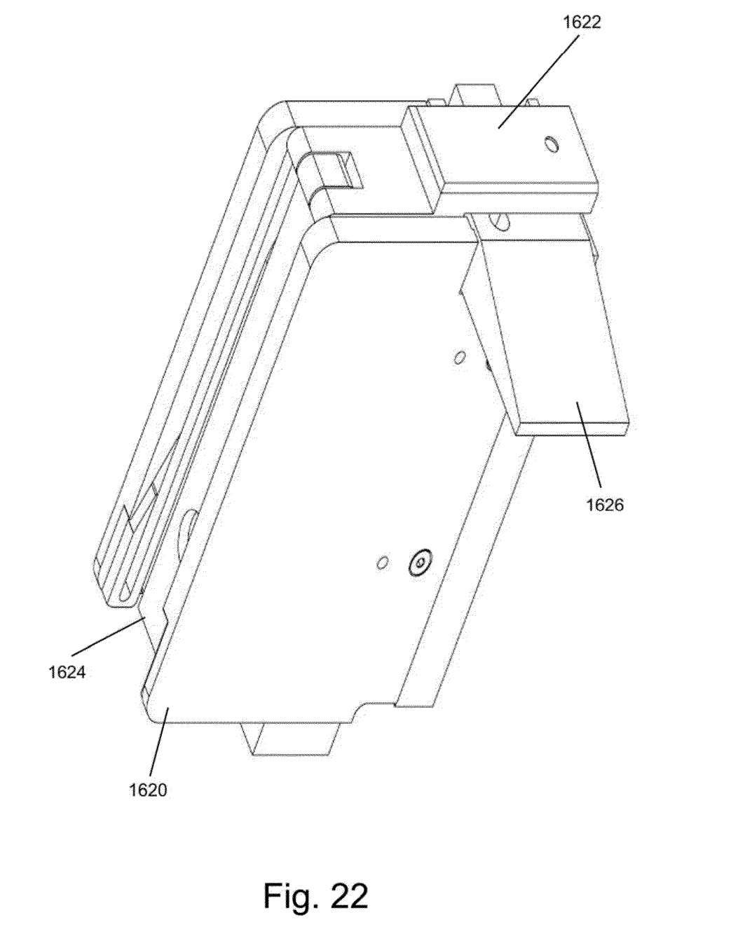

FIGS. 17 through 22 represent one embodiment of a carton marker cover. In the embodiment contained therein, the carton marker cover 1620 encompasses the thermal inkjet cartridge 1610 thereby providing protection against environmental elements such as moisture and greater thermal stability. The carton marker cover 1620 has a printing face cover 1622 and a print head cover latch 1624. The carton marker cover has two configured positions “closed”’ (as shown in FIG. 18) and “open” (as shown in FIG. 22), which can be alternated through use of the print head cover latch 1624. While in the “closed” position, the printing face cover 1622 provides an airtight seal around the printing face 1612. This is accomplished by placing foam rubber, or any other suitable sealing material, at the point of contact between the print face cover 1622 and the printing face 1612. The print head cover latch 1624 may also be raised to gain access to the thermal inkjet cartridge 1610 contained within the carton marker cover 1620 (FIG. 19).

The carton marker cover 1620 also contains a ramped guidance section 1626 (FIG. 22) located at the front end of the carton marker cover 1620 which projects towards the incoming egg cartons. The ramped guidance section 1626 protects the printing face 1612 in the event that unclosed or defective cartons pass through the carton marking system which could potentially contact the printing face 1612. This ramp feature on the front of the housing maintains throw distance between nozzles and substrate. This ramp can be affixed in the reverse direction to allow printing on cartons approaching from the other direction.

In some embodiments of the present disclosure, spring-loading of the latching mechanism is provided by the elasticity of the seal material.

The embodiments disclosed herein have several advantages over the prior art. The cover protects against damage to the delicate cartridge and specifically the nozzles and the electrical contacts. The cover also seals the nozzles in the cartridge when closed, extending cartridge life, and reducing the need for bleeding when starting up. Pressure is applied to the seal directly as a result of the closing and latching action. The sealing process allows the cartridges to be left in-situ during cleaning and extended downtime, reducing the time-consuming production process step to fit and test the cartridges before restarting production. The design of the cover allows the cover to open up to allow quick and straightforward cartridge removal, using the same removal technique as though the cover were not there (FIG. 19).

In some embodiments, the design of the cover allows quick changeovers between ink types, such ink type changes may be required to optimize or improve the printing for different designs and materials of the cartons.

In a preferred embodiment, the covers can accommodate a pair of printing stations, arranged opposing one another with ramps arranged in opposing directions, in order to accommodate printing on both ends of the same carton. A recess on the trailing edge (post print) side of the cover assembly allows small clearances (as small as 0.010″) to be maintained between the print substrate and the cartridge assembly during and after printing, The recess prevents smudging of the print. It also prevents creation and/or gathering of dust, sediment, or carton fibers that might impact the quality of the final print on the carton. For instance, the fibers may get pushed into the nozzles of the print head making them non-functional due to clogging. The current system thus avoids clogging, which can cause poor quality print or illegible print.

In still other embodiments, mechanical tracks and associated pins control the motion of the various components for optimum performance. The mechanical tracks include a “removal” portion of the track, allowing assembly and removal of the cover mechanism. The cover fits using existing holes and alignment pins in the standard cartridge holder device. No special features are required in the standard cartridge holder device.

It will be understood that various aspects or details of the invention may be changed without departing from the scope of the invention. It is not exhaustive and does not limit the claimed inventions to the precise form disclosed. Furthermore, the foregoing description is for the purpose of illustration only, and not for the purpose of limitation. Modifications and variations are possible in light of the above description or may be acquired from practicing the invention. The claims and their equivalents define the scope of the invention.

1. An object printing system comprising:
a conveyor object packer capable of packing objects into an object container;
at least one print head placed over the conveyor that is able to be positioned above an object in the object container after the object container has been filled by the object packer and the print head printing during a dwell period; and
a controller that receives information associated with the object that also is associated with the printing, where the information results in a change in the printing.

2. The system of claim 1 wherein the objects are eggs.

3. The system of claim 1, wherein the print heads are laser print heads, and further comprising a configuration of laser print head assemblies with multiple positions capable of lasing in two or more successive positions.

4. The system of claim 3, wherein the laser print assemblies are configured in three sets of two laser print heads per set of laser print assemblies.

5. The system of claim 4, further comprising a plurality of sets of extraction piping, one for each of the laser print head assemblies, connected to a central vacuum manifold, with each inlet pipe located centrally between the two objects being lased.

6. The system of claim 5 wherein the extraction piping provides an even airflow over the area being marked.

7. The system of claim 5, further comprising an extraction hood that is quick-release for easy cleaning and to allow access to objects underneath when needed, and wherein the extraction piping is easily removable for quicker and more effective cleaning.

8. The system of claim 3 wherein the laser assemblies are configured to accommodate 12-packs, 18-packs, 24-packs, 30-packs, 36-packs, and 20-packs of objects.

9. The system of claim 1, further comprising an open-frame conveyor design that is formed using guides and chains that facilitate ready cleaning compared to traditional bed covers.

10. An object printing system comprising:
a conveyor object packer capable of packing objects into an object container;
at least one laser print head having an associated shutter placed in either an open position or a closed position placed over the conveyor and that is able to be positioned above an object in the object container after the object container has been filled by the object packer and the laser print head printing during a dwell period; and
a controller that receives information associated with the object that also is associated with the laser head printing, where the information results in a change in the laser head printing.

11. The system of claim 10 wherein one or more of the laser shutters move or are placed in a closed position when its associated laser lens needs protection, when the main laser guards are opened, or when the main laser guards are removed.

12. The system of claim 10 wherein the laser shutters are sized to allow the full laser beam path when in the open position.

13. The system of claim 10, further comprising an air purge for the lens comprising:
a vacuum; and
slots allowing air into the lower pressure area such that the air purge forces air away from the lens to remove debris resulting from any laser marking.

14. The system of claim 13, wherein the air purge comprises pressurized air.

15. A carton marking system for use with the carton closing system of an object packer, the carton marking system comprising:
two distance railings situated on both sides of the closing system's conveyor chain, parallel to the path of motion of the conveyor chain, wherein the distance railings taper away from the conveyance chain at the point of entry;
flexibly resistant members that push the distance railings toward the conveyance chain and provide a gentle force on the cartons so as to hold the cartons at an optimal distance for print quality of information on one or more side of the carton.

16. The system of claim 15, wherein thermal ink jet cartridges are used for printing on the cartons and wherein the thermal inkjet cartridges are attached to the distance railings.

17. The system of claim 15, wherein laser marking systems are used for printing on the cartons and wherein the laser marking system laser print heads are attached to the distance railings instead of a thermal ink jet cartridge.

18. The system of claim 15, further comprising carton marking covers for the carton marking devices, the carton marking covers comprising:
a printing face cover; and
a print head cover latch.

19. The system of claim 18, wherein the carton marking cover has an open configured position and a closed configured position, which can be alternated through use of the print head cover latch, and wherein while in the closed position, the printing face cover provides an airtight seal around the printing face.

20. The system of claim 19, wherein the carton marker cover further comprises:
a ramped guidance section located at the front end of the carton marking cover, said ramped guidance section projecting towards the incoming egg cartons, and said ramped guidance section protecting the printing face in the event unclosed or defective cartons pass through the carton marking system; and
wherein said ramped guidance system maintains the desired throw distance between printing nozzles and the carton substrate.
